(19) United States
(12) Patent Application Publication
(10) Pub. No.: US 2009/0237941 A1
(43) Pub. Date: Sep. 24, 2009

(54) Illumination Optics

(76) Inventor: Philip A. Premysler, Boca Raton, FL (US)

Correspondence Address: PHILIP PREMYSLER, 23090 POST GARDENS WAY #306, BOCA RATON, FL, 33433, US

(21) Appl. No.: 12/087,399

(22) PCT Filed: Jan. 8, 2007
(86) PCT No.: PCT/US2007/000290

§ 371 Date: Jul. 3, 2008

Related U.S. Application Data
(60) Provisional application No. 60/758,046, filed on Jan. 11, 2006.

(51) Int. Cl. F21V 7/07; F21V 5/04

(52) U.S. Cl. 362/296.05; 362/335

(57) ABSTRACT

Luminaire optics (300, 1100, 1500) comprise a complementary reflector (302, 402, 902, 1008, 1104, 1202, 1606, 1702, 1802, 1902, 2002) and lens (304, 404, 704, 904, 1024, 1108, 1204, 1610, 1704, 1804, 1904, 2004) that are described by a set of coupled differential equations. The luminaire optics are able to distribute light substantially according to a predetermined specified light intensity distribution, while at the same time collimating the light to a relatively high degree.

### FIELD OF THE INVENTION

The present invention relates generally to illumination optics.

### BACKGROUND

In many technical applications, it is desirable to collect a high percentage of light that is emitted from a light source and to direct the collected light to an area (or object) to be illuminated. Examples of such applications include machines which use light in the processing of semiconductor wafers and image projectors (e.g., film projectors, LCD projectors, and DLP projectors).

For many applications it would be desirable to be able to collect a high percentage of light emitted by a lamp, distribute the collected light within an area (or on an object) to be illuminated in a highly controlled manner (e.g., uniformly) and have the light incident on the area (or object) collimated.

### BRIEF DESCRIPTION OF THE FIGURES

The present invention will be described by way of exemplary embodiments, but not limitations, illustrated in the accompanying drawings in which like references denote similar elements, and in which:

FIG. 1 is a view of compact arc lamp;

FIG. 2 is a plot of luminance weighted by the cosine of elevation angle as a function of the elevation angle for a compact arc lamp such as shown in FIG. 1;

FIG. 3 is a schematic diagram of luminaire optics according to certain embodiments of the invention;

FIG. 4 is a graph including plots of profiles of a first reflector and a first lens according to an embodiment of the invention;

FIG. 5 is a plot of light intensity verses radial position that is produced by a luminaire when using the first reflector and the first lens having the profiles shown in FIG. 4 with the compact arc lamp having the cosine weighted luminance shown in FIG. 2;

FIG. 6 is a surface plot that shows light intensity plotted against radial position and against an index related to the magnitude of a component of ray vectors parallel to an optical axis when using the first reflector and first lens having the profiles shown in FIG. 4 with the compact arc lamp having the cosine weighted luminance shown in FIG. 2;

FIG. 7 is a graph including plots of profiles of a second reflector and a second lens according to an embodiment of the invention;

FIG. 8 is a plot of light intensity versus radial position that is produced by a luminaire using the second reflector and the second lens having the profiles shown in FIG. 7 with the compact arc lamp having the cosine weighted luminance shown in FIG. 2;

FIG. 9 is a cross-sectional side view of a luminaire and including an associated lens according to an embodiment of the invention;

FIG. 10 is a cross-sectional side view of a luminaire according to an embodiment of the invention;

FIG. 11 is a schematic diagram of luminaire optics according to certain embodiments of the invention;

FIG. 12 is a graph including plots of profiles of a third reflector and third lens according to an embodiment of the invention;

FIG. 13 is a plot of light intensity versus radial position that is produced by a luminaire using the third reflector and the third lens with the compact arc lamp having the cosine weighted luminance shown in FIG. 2;

FIG. 14 is surface plot that shows light intensity plotted against radial position and against an index related to the magnitude of the component of ray vectors parallel to an optical axis using the third reflector and third lens having the profiles shown in FIG. 12 with the compact arc lamp having the cosine weighted luminance shown in FIG. 2;

FIG. 15 is a schematic diagram of luminaire optics according to certain embodiments of the invention;

FIG. 16 is a cross-sectional side view of a lens and a luminaire including a reflector according to an embodiment of the invention;

FIGS. 17-20 are schematic illustrations of profiles of reflectors and lenses according to certain embodiments of the invention;

FIG. 21 is a flowchart of a method of manufacturing complementary lenses and reflectors for luminaires according to embodiments of the invention;

FIG. 22 is a flowchart of a method of manufacturing complementary lenses and reflectors for luminaires according to embodiments of the invention;

FIG. 23 is a flowchart of an alternative beginning of the first or second methods shown in FIGS. 21-22; and

FIG. 24 is a flowchart of a subprogram that is called by an optimization routine that is called in the flowchart shown in FIG. 23; and

FIG. 25 is a block diagram of a projector system according to embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

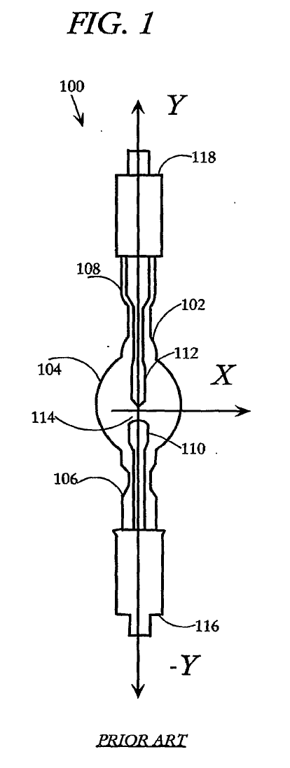

FIG. 1 is a view of compact arc lamp 100. The compact arc lamp 100 comprises a transparent envelope 102 which comprises a central discharge containing bulb portion 104, a first stem portion 106 extending from the bulb portion 104, and a second stem portion 108 that extends from the bulb portion 104 opposite the first stem portion 106. An anode 110 and a cathode 112 are located in the bulb portion 104 and are spaced from each other forming a discharge gap 114. The bulb portion 104 also contains a discharge fill (not visible) including one or more gases, metals and/or compounds. The anode 110 is connected to an anode terminal 116 located at a distal end of the first stem portion 106. The cathode 112 is connected to a cathode terminal 118 located at a distal end of the second stem portion 108. When energized by applying power from a power supply (not shown) across the anode terminal 116 and the cathode terminal 118 the discharge fill becomes ionized and emits light. The name of the compact arc lamp 100 derives from the relatively small gap 114 between the anode 110 and the cathode 112 (compared to other discharge lamps), and from the small size of the light emitting discharge that is formed in the gap 114 when the lamp 100 is powered. Compact arc lamps are considered quasi point sources. An X-Y coordinate system is drawn on the lamp 100 for reference. The Y-axis is aligned on a longitudinal axis of the lamp 100 about which the lamp 100 is substantially rotationally symmetric. The origin of the X-Y coordinate system is conveniently located in the discharge gap 114. Note that the compact arc lamp 100 is but one type of lamp that is to be used in the luminaries according to the present invention. Incandescent bulbs or other types of bulbs are alternatively used in luminaries according to the teachings described hereinbelow. However, the luminaire optics described herein are particularly suited to compact arc lamps because the luminaire optics described herein are able to collect a substation portion of light emitted by compact arc lamps notwithstanding the fact that compact arc lamps emit light over a substantial though not full range of elevation angle, and to substantially collimate and distribute the light in a highly controlled manner.

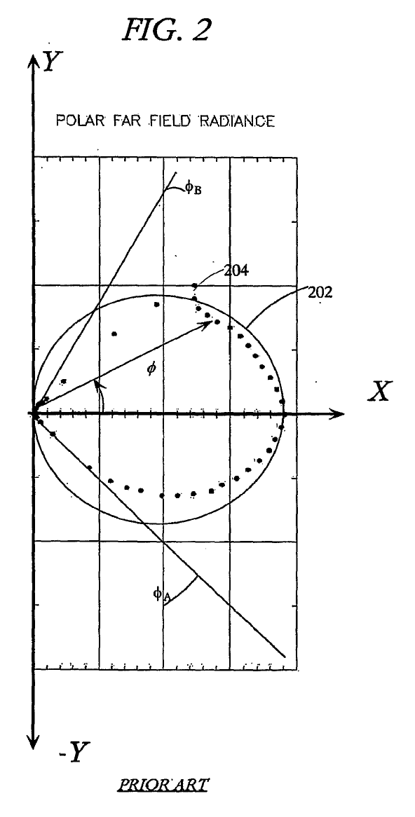

FIG. 2 is a plot of luminance weighted by the cosine of the elevation angle φ as a function of elevation angle φ for a compact arc lamp of the general type shown in FIG. 1. In particular, the example data shown in FIG. 2 is from a 160 Watt DC “SHP” model Mercury Xenon lamp manufactured by Phoenix Electric of Hyogo Prefecture Japan. The plot shown in FIG. 2 was generated using light rays generated using a ProSource™ light source model software (version 6.2.4.) which is published by Radiant Imaging of Duvall Wash., in conjunction with a ProSource™ model. The ProSource™ model is based on measurements of the lamp using a photopic filter.

The coordinate system shown in FIG. 1 is retained in FIG. 2. The elevation angle denoted φ is measured, in the counterclockwise direction, from the X-axis. In as much as light radiated by the lamp 100 is not limited to a plane it is appropriate to consider a Z-axis that extends from the origin perpendicular to the X-Y plane (out of the plane of the drawing sheet). Given the addition of the Z-axis, it is noted that the elevation angle φ is, in fact, measured from the X-Z plane. The luminance shown in FIG. 2 is weighted by the cosine of the elevation angle φ because a factor of cos(φ) relates a differential of elevation angle Δφ to a differential of solid angle, which is to say that the amount of light available within a differential of elevation angle, at a particular elevation angle is proportional to the product of the light intensity (e.g., radiance or luminance) at the particular elevation angle multiplied by cos(φ).

Although compact arc lamp lamps (e.g. 100) can exhibit some transient flicker, the time average light intensity distribution (radiance or luminance) is nominally rotationally symmetric about the longitudinal axes of compact arc lamps (e.g. 100), which coincides with the Y-axis shown in FIGS. 1-2. In other words the radiance is nominally uniform as a function of azimuth angle. On the other hand, as shown in FIG. 2, the light intensity distribution is not uniform as a function of elevation angle. For comparison, reference circle 202 shows what the light intensity distribution weighted by the cos(φ) would be if the light intensity distribution were uniform as a function of elevation angle. Note that the actual light intensity distribution is not symmetric about the X-Z plane. Also, note the small peak 204. Note also that the light intensity distribution of a compact arc lamp (e.g. 100) is substantially confined to a range of elevation angle that extends upward and downward from the X-Z plane by less than ninety degrees. For the lamp on which FIG. 2 is based there is substantial light intensity between −45 degrees (π/4 radians) and +50 degrees (0.873 radians), and there is a non-negligible flank that extends up to about +75 degrees (1.31 radians). The light intensity along the optical axis (Y-axis) in both the positive and negative directions is substantially zero. The elevation angle is limited due to obstructions by the anode 110 and cathode 112. In FIG. 2 nominal lower and upper bounds of the elevation angle range in which the compact arc lamp 100 emits are denoted φ_{A} and φ_{B} respectively. There may be some minimal detectable light emitted outside the bounds.

Parts of the bulb portion 104 can be covered with a reflective coating in order to further restrict the angular range light emission and enhance the brightness of light emitted in the restricted angular range. Optics disclosed below can be used with bulbs having partial reflective coatings as well as bulbs without such coatings.

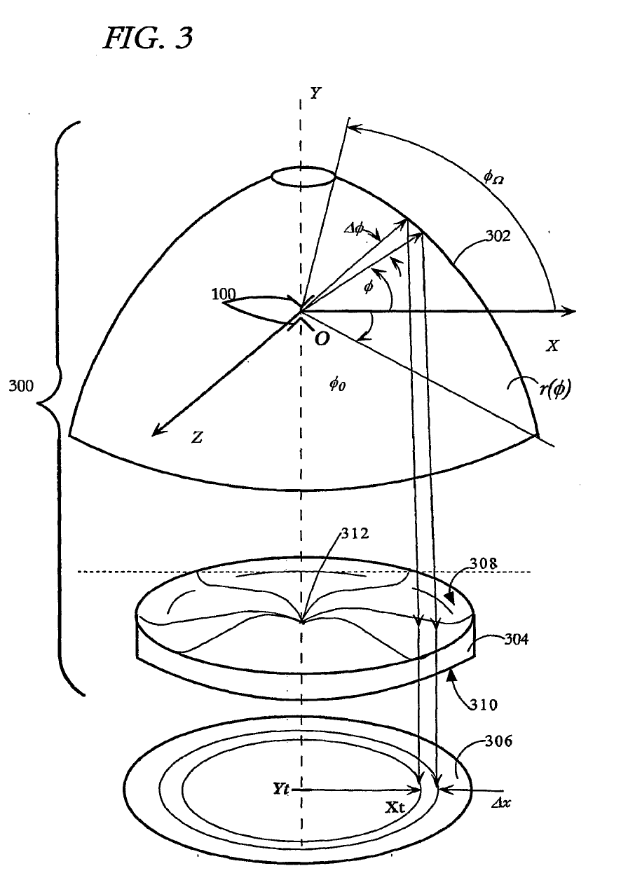

FIG. 3 is a schematic diagram of a set of luminaire optics 300 according to certain embodiments of the invention. In FIG. 3 the full X-Y-Z coordinate system alluded to earlier is shown. The Y-axis is an optical axis for the set of luminaire optics 300. A lamp (e.g., 100) is schematically represented in FIG. 3 by a pair of opposed chevrons. The set of luminaire optics 300 comprises a reflector 302 and a complementary lens 304. (The chevrons representing the lamp (e.g., 100) are seen through the reflector 302, as though in an X-ray view.) The reflector 302 reflects light emitted by the compact arc lamp 100 to the lens 304. The reflector 302 and the lens 304 are shaped so that light is distributed on an illuminated plane 306 located beyond the lens 304 approximately according to a specified radial distribution (e.g., uniformly). The illuminated plane 306 is a mathematically specified plane that may or may not include an actual physical object (e.g., light modulator, semiconductor wafer, photosensitive coating, etc.) The illuminated plane may simply be a specified plane in an optical system. Rays are incident on the lens 304 are not directed as though convergent to or divergent from a focal point. The lens 304 has a top surface 308 that is shaped to refract rays reflected by the reflector 302 in order to produce a collimated beam of light. The lens top surface 308 has an axial coordinate (Y-coordinate) that varies as a function of radial cylindrical coordinate. In the X-Y-Z coordinate system shown in FIG. 3 the radial cylindrical coordinate is (X²+Z²)^{1/2}. The top surface 308 of the lens 304 is continuous and continuously differentiable except at the center where there is a reentrant peak 312. This feature arises because the lamp 100 does not emit light along the Y-axis. Light emitted at a particular elevation angle, e.g., a maximum elevation angle of the reflector will be reflected to the center of the lens. However, the light will come from the full 2π of azimuth angle, and each azimuth angle dictates a different orientation of the lens surface at the center in order to achieve collimation, hence the reentrant peak 312, where the surface 308 is not differentiable. The lens 304 also includes a bottom surface 310. In most applications a planar bottom surface 310 is used, in which case collimation achieved by the top surface 308 is not disturbed by the bottom surface 310. The luminaire optics 300 are able to achieve controlled distribution of light closely approximating specified desired distributions and a high degree of collimation. FIG. 3 includes an idealized depiction of how light emitted within a differential of solid angle corresponding to a differential of elevation angle Δφ, at particular elevation angle φ is reflected into an annulus having a radius x and a differential width Δx. (Note that the differential of solid angle that maps into the annulus spans a complete 2π range of azimuth angle.

The reflector 302 and lens 304 and other reflectors described hereinbelow can be complete surfaces of revolution, such that light emitted by a source (e.g., compact arc lamp 100) is distributed over a circular area of the illuminated plane 306. (According to alternative embodiments only off-axis portions of the reflectors and lenses are used). Profiles or generatrices of the reflector 302 and top surface 308 of the lens 304 and of other complementary reflectors and lens for illuminaires are given by the following system of differential equations defined in the domain of elevation angle coordinate φ:

$$\begin{matrix}( LENS EQUATION ) & \\ \frac{\partial }{\partial φ} Yr ( φ ) = \frac{cos ( - φ + 2 arctan ( \frac{\frac{\partial }{\partial φ} r ( φ )}{r ( φ )} ) ) F DIST}{- sin ( - φ + 2 arctan ( \frac{\frac{\partial }{\partial φ} r ( φ )}{r ( φ )} ) ) - Nlens} . & EQU . 1\end{matrix}$$

$$\text{(REFLECTOR EQUATION)} \qquad \qquad EQU . 2$$

$$\frac{{\partial }^{2}}{\partial {φ}^{2}} r ( φ ) = - ( \begin{matrix}- ( \begin{matrix}\frac{cos ( - φ + 2 arc tan ( \frac{\frac{\partial }{\partial φ} r ( φ )}{r ( φ )} ) ) F DIST}{- sin ( - φ + 2 arc tan ( \frac{\frac{\partial }{\partial φ} r ( φ )}{r ( φ )} ) ) - Nlens} - ( \frac{\partial }{\partial φ} r ( φ ) ) sin ( φ ) - r ( φ ) cos ( φ ) - \\ ( 1 + {tan ( - φ + 2 arc tan ( \frac{\frac{\partial }{\partial φ} r ( φ )}{r ( φ )} ) )}^{2} ) ( - 1 - 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} ) r ( φ ) cos ( φ ) - \\ tan ( - φ + 2 arc tan ( \frac{\frac{\partial }{\partial φ} r ( φ )}{r ( φ )} ) ) ( \frac{\partial }{\partial φ} r ( φ ) ) cos ( φ ) + tan ( - φ + 2 arc tan ( \frac{\frac{\partial }{\partial φ} r ( φ )}{r ( φ )} ) ) r ( φ ) sin ( φ )\end{matrix} ) / tan ( - φ + 2 arc tan ( \frac{\frac{\partial }{\partial φ} r ( φ )}{r ( φ )} ) ) + \\ ( \begin{matrix}( Yr ( φ ) - r ( φ ) sin ( φ ) - tan ( - φ + 2 arc tan ( \frac{\frac{\partial }{\partial φ} r ( φ )}{r ( φ )} ) ) r ( φ ) cos ( φ ) ) \\ ( 1 + {tan ( - φ + 2 arc tan ( \frac{\frac{\partial }{\partial φ} r ( φ )}{r ( φ )} ) )}^{2} ) ( - 1 - 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} )\end{matrix} ) / tan {( - φ + 2 arc tan ( \frac{\frac{\partial }{\partial φ} r ( φ )}{r ( φ )} ) )}^{2} + F DIST\end{matrix} ) / ( 2 \frac{( 1 + {tan ( - φ + 2 arc tan ( \frac{\frac{\partial }{\partial φ} r ( φ )}{r ( φ )} ) )}^{2} ) cos ( φ )}{( 1 + \frac{{( \frac{\partial }{\partial φ} r ( φ ) )}^{2}}{{r ( φ )}^{2}} ) tan ( - φ + 2 arc tan ( \frac{\frac{\partial }{\partial φ} r ( φ )}{r ( φ )} ) )} + 2 ( \begin{matrix}( \begin{matrix}Yr ( φ ) - r ( φ ) sin ( φ ) - \\ tan ( - φ + 2 arc tan ( \frac{\frac{\partial }{\partial φ} r ( φ )}{r ( φ )} ) ) r ( φ ) cos ( φ )\end{matrix} ) \\ ( 1 + {tan ( - φ + 2 arc tan ( \frac{\frac{\partial }{\partial φ} r ( φ )}{r ( φ )} ) )}^{2} )\end{matrix} ) / ( \begin{matrix}{tan ( - φ + 2 arc tan ( \frac{\frac{\partial }{\partial φ} r ( φ )}{r ( φ )} ) )}^{2} \\ r ( φ ) ( 1 + \frac{{( \frac{\partial }{\partial φ} r ( φ ) )}^{2}}{{r ( φ )}^{2}} )\end{matrix} ) )$$

where,
φ is the domain variable of the domain in which the equations 1 and 2 are defined and also the elevation angle coordinate of the generatrix of the reflector 302; (φ is measured in a counterclockwise direction from the X-axis of the X-Y coordinate system.)
r(φ) is a polar radial coordinate of the generatrix of the reflector 302 (in the X-Y coordinate system r(φ) is equal to \sqrt{x²+y²});
Yr(φ) is equal to the Y coordinate of the generatrix of the lens;
Nlens is the index of refraction of the lens 304;

$$DIST = \pm \frac{\begin{matrix}2 π cos ( φ ) \cdot {r}_{R} ( {θ}_{i\_R} ) \cdot \\ {t}_{L} ( {θ}_{i\_L} ) Rad ( φ )\end{matrix}}{2 π Xt ( φ ) \cdot {I}_{rr} ( Xt )} \frac{{\int }_{{X}_{MIN}}^{{X}_{MAX}} Xt \cdot Irr ( Xt ) d x}{{\int }_{{φ}_{0}}^{{φ}_{Ω}} cos ( φ ) \cdot Rad ( φ ) d φ} \qquad EQU . 3$$

where,
θᵢ_{_{—}}_{R} is an angle of incidence on the reflector 302 given by:

$${θ}_{i\_R} = arc tan \{ \frac{1}{r ( φ )} \frac{\partial r ( φ )}{\partial φ} \}$$

r_{R}(θᵢ_{_{—}}_{R}) is the reflectance of the reflector for light incident at angle of incidence θᵢ_{_{—}}_{R}; (For reflectors with reflective surfaces that exhibit a small variation of reflectivity with incidence angle {e.g., silver, aluminum} r_{R}(θᵢ_{_{—}}_{R}) is suitably set to 1, without incurring a significant penalty in the performance of the luminaire optics 300)
θᵢ_{_{—}}_{L} is an angle of incidence on the lens 304 given by:

$${θ}_{i\_L} := - \frac{1}{2} π + φ - 2 arc tan ( \frac{\frac{\partial }{\partial φ} r ( φ )}{r ( φ )} ) - arc tan ( - \frac{cos ( \begin{matrix}φ - 2 \\ arc tan\end{matrix} ( \frac{\frac{\partial }{\partial φ} r ( φ )}{r ( φ )} ) )}{sin ( \begin{matrix}φ - 2 \\ arc tan\end{matrix} ( \frac{\frac{\partial }{\partial φ} r ( φ )}{r ( φ )} ) ) - Nlens} )$$

t_{L}(θᵢ_{_{—}}_{L}) is the angle of incidence dependent transmittance of the top surface 308 of the lens; (Note for an uncoated lens the transmittance t_{L}(θᵢ_{_{—}}_{L}) is given by Fresnel formulas. See for example J. R. Reitz et al, “Foundations of Electromagnetic Theory” Addison Wesley, 1980. If an antireflection coating that is able to substantially reduce reflection from the top surface 308 of the lens 304 is used the factor t_{L}(θᵢ_{_{—}}_{L}) in DIST can be set equal to one, without incurring a substantial penalty in the performance of the luminaire optics.)
Xt(φ) is the X-coordinate on illuminated plane 306 (and on the top surface 308 of the lens) to which a ray emanating at an elevation angle φ (in the X-Y coordinate system) from the origin of the X-Y coordinate system would be directed the luminaire optics 300, and is given by:

$$Xt := - \frac{\begin{matrix}Yr ( φ ) - r ( φ ) sin ( φ ) - \\ tan ( - φ + 2 arc tan ( \frac{\frac{\partial }{\partial φ} r ( φ )}{r ( φ )} ) ) r ( φ ) cos ( φ )\end{matrix}}{tan ( - φ + 2 arc tan ( \frac{\frac{\partial }{\partial φ} r ( φ )}{r ( φ )} ) )} \qquad EQU . 4$$

(Note that in using Xt it is assumed that the generatrix of the reflector is being derived in the X-Y coordinate system. In a cylindrical coordinate system coincident with the full X-Y-Z coordinate system Xt is a cylindrical radial coordinate. Note that the cylindrical radial coordinate on the illuminated plane 302 is defined as \sqrt{x²+z²}.)

Irr(Xt) is a predetermined desired light intensity (irradiance or illuminance) at a given cylindrical radial coordinate on the illuminated plane 306;

Rad(φ) is the intensity of light (e.g., radiance or luminance) emitted by a light source (e.g., 100), for which the reflector 302 and lens 304 are designed, at elevation angle φ; (Note as indicated above in reference to FIG. 2 that the radiance varies as a function of elevation angle φ)

X_{MIN} is the inner radius of an annulus of the illuminated plane 306 to be illuminated by the luminaire optics 300; (Note that if a circular area of the illuminated plane 306 is illuminated X_{MIN} is equal to zero.)

X_{MAX} is an outer radius of an annulus or circular area of the illuminated plane 306 to be illuminated by the luminaire optics 300;

φ₀ is the lower limit of the elevation angle range subtended by the reflector 302;

φ_{Ω} is the upper limit of the elevation angle range subtended by the reflector 302;

F is a normalization factor that compensates for reflection losses given by r_{R}(θᵢ_{_{—}}_{R}) and transmission losses given by t_{L}(θᵢ_{_{—}}_{L});

with initial conditions r(φ₀), ∂r/∂φ₀, Yr(φ₀).

F needs to be determined by trial and error (e.g., by a numerical root finding method) such that Xt(φ_{Ω}, r(φ_{Ω}), ∂r(φ)/∂φ (at φ_{Ω}), Yr(φ_{Ω}))=X_{Ω} where X_{Ω} is a chosen value of X (either X_{MIN} or X_{MAX} to which a ray emanating from the origin at angle φ_{Ω} is to be directed by the luminaire optics 300. Determination of F is best started at an approximate value which is equal to the inverse of the product of estimates for average values for r_{R}(θᵢ_{_{—}}_{R}) t_{L}(θᵢ_{_{—}}_{L}). For example if r_{R}(θᵢ_{_{—}}_{R}) has an estimated average value of 0.98, and the lens has an index of refraction equal to 1.5, F is approximately equal to 1/(0.96*0.98), 0.96 being the nominal value for reflectance from the surface of an uncoated lens of index of refraction 1.5. If both factors r_{R}(θᵢ_{_{—}}_{R}) t_{L}(θᵢ_{_{—}}_{L}) are set to one F is also set equal to one;

The initial condition r(φ₀) determines the transverse dimension of the reflector. Thus r(φ₀) is suitably selected small enough to fit within a space allowed for the reflector, however r(φ₀) should not be made so small that it approaches the dimension of the light source. r(φ₀), and Yr(φ₀) should be chosen to avoid large angles of incidence of light on lens θᵢ_{_{—}}_{L}, which could cause the lens to reflect substantial light energy. For a lens having index of refraction of 1.5 and an uncoated top surface 308 it is best to avoid angles of incidence above 70 degrees, at which point transmission of the top surface is down to 80%.

Once r(φ₀) and, Yr(φ₀) have been selected ∂r/∂φ at φ₀ is determined by:

$${\frac{\partial r }{\partial φ} \vert}_{φ = {φ}_{o}} = r ( {φ}_{0} ) * tan \{ \frac{{φ}_{0}}{2} + \frac{arc tan \{ \frac{\begin{matrix}r ( {φ}_{0} ) * \\ cos ( {φ}_{0} ) - {x}_{0}\end{matrix}}{\begin{matrix}r ( {φ}_{0} ) * \\ sin ( {φ}_{0} ) - Yr ( {φ}_{0} )\end{matrix}} \}}{2} - \frac{π}{4} \} \qquad EQU . 5$$

where X₀ is a chosen radial coordinate to which a ray emanating from the origin at angle φ₀ is to be directed by the luminaire optics 300. X₀ is set equal to X_{MAX} or X_{MIN}.

Xt(φ) and Yr(φ) parametrically define the top surface 308 of the lens, with φ acting as the parameter.

Rad(φ) is based on measurements of the light source (e.g., 100) for which the reflector 302 and lens 304 are designed. For real world lamps Rad(φ) is nonuniform, which is to say Rad(φ) is a non-constant function of φ. (Rad(φ) is suitably represented as a interpolating spline, such as a cubic spline). Irr(Xt) can be represented by a single mathematical function or a piecewise defined mathematical function such as a cubic spline. To specify a uniform distribution on the illuminated plane Irr(Xt) is set equal to a constant e.g., 1.

For certain applications it may be desirable to place a partial reflector on the bottom surface 310 of the lens 304 or adjacent to the bottom surface 310. The partial reflector, can for example, comprise a polarization selective reflector (e.g., an array of conductive traces formed by lithography) or a spectrally selective reflector (e.g., a multilayer interference coating). Alternatively, a wave plate (e.g., a one-quarter wave plate), followed by a polarizer can be located at the bottom surface 310. The wave plate will alter the polarization of light reflected by the polarizer such that when the light is incident on the polarizer again, the light will be of the correct polarization to pass through the polarizer.

Alternatively, the partial reflector can reflect all wavelengths and polarizations but only cover a portion of the bottom surface. The partial reflector will retroreflect light back toward the source. Some of this light will pass through the light source and contribute to Rad(φ) in which case Rad(φ) will be the sum of direct emission contribution and a retroreflected contribution. The amount of light that can pass back through the bulb and reemerge as useful light can be determined experimentally for individual bulbs, if use of retroreflection is desired. (Note that retroreflection will reverse the sign of the elevation angle of rays, such that a ray originally emitted at angle φ after being retroreflected and passing through the light source will emerge at elevation angle −φ.) A peripheral area of the bottom surface 110 defining a square or rectangular area can be covered with a reflector. Note that the light retroreflected by an area with a rectangular or square area will introduce some azimuthal nonuniformities in Rad(φ) but this may be tolerable for certain applications and may be mitigated with a low angle diffuser.

Alternatively, the partial reflector can be include discrete regions with different dichroic transmission curves. For example for color correcting a lamp that exhibits elevation angle color separation, a pattern of concentric ring shaped dichroic reflectors can be applied to the bottom surface 310. Alternatively, tiled pattern of red, blue and green dichroic filters can be applied to the bottom surface, and relay optics can be used to image the tiled pattern onto a spatial image modulator.

Note that there is a singularity in DIST in equations 1 and 2, when Xt is equal to zero. In the case that a circular area of the illuminated plane 306 is to be illuminated it may be necessary for certain numerical differential equation integrators to select Xmin equal to some small, physically insignificant, value, rather than zero in order to avoid the singularity causing difficulties for the integrator. For example selecting Xmin=0.001 mm as opposed to Xmin=0.0 can avoid problems caused by the singularity for certain integrators.

Luminaire optics described by equation 1 and equation 2 are able to efficiently collect light from non-uniformly emitting sources and illuminate areas including relatively small areas (e.g., areas the size of a projection image modulator) with a relatively high degree of accuracy according to predetermined specified radial intensity distributions Irr(Xt), and to achieve a high degree of collimation. Note that despite that the fact that the light source (e.g., lamp 100) does not in general maintain the same radiance or luminance over a large portion of the angular range over which the source emits, φ₀ and φ_{Ω} can be set wide apart to collect a high percentage of emitted light while still achieving relatively accurate approximation of a desired light intensity distribution and a high degree of collimation. Examples given below illustrate achievable levels of intensity distribution accuracy and collimation. Note that luminaire optics defined by equations 1 and 2 are able to illuminate objects that are close to the luminaire. Additionally, luminaire optics described by equation 1 and equation 2 are able to distribute light in a highly controlled manner within illuminated areas that have a transverse dimension that is not so large that the transverse dimension of the reflector is negligible in comparison. In fact, in several examples shown below, the transverse dimension of the illuminated area, which is substantially equal to the transverse dimension of the lens, is smaller than the transverse dimension of the reflector.

Note that there is either a plus or minus sign in front of the DIST sub-expression. A plus sign in front of the DIST subexpression specifies luminaire optics that distribute light such that as the elevation angle φ of a ray emanating from the source (e.g. 100) is increased, the intercept of the ray with the illuminated plane, Xt decreases. On the other hand, equation 1 and equation 2 with a minus sign in front of the DIST subexpression specifies luminaire optics that distribute light such that as the elevation angle φ of a ray emanating from the source (e.g. 100) is increased, the illuminated plane intercept, Xt increases.

To integrate equations 1 and 2-numerically one makes the following substitution:

$$\frac{\partial r ( φ ) }{\partial φ} = V ( φ ) \qquad EQU . 6$$

where, V is a dummy variable,

in equations 1 and 2 in order to convert equations 1 and 2 into a system of three first order differential equations that are equivalent to equations 1 and 2.

The system of three first order differential equations are then integrated numerically in order to determine the shape of the generatrix of a reflector. The system of differential equations can be integrated using Ordinary Differentia Equation (ODE) integrators that are included in computer algebra system (CAS), such as, for example, MAPLE V® by Maplesoft of Waterloo, Ontario, Canada, Mathematica® by Wolfram Research, Inc. of Champaign, Ill. systems or using other commercially or publicly available ODE integrators. The inventor has used Maple V, and the FORTRAN Runge-Kutta ODE integrators included in the IMSL library published by Visual Numerics of Houston, Tex. A straightforward approach is to integrate the system of equations in the forward direction starting at the lowest value of the independent variable, the elevation angle φ, which is φ₀.

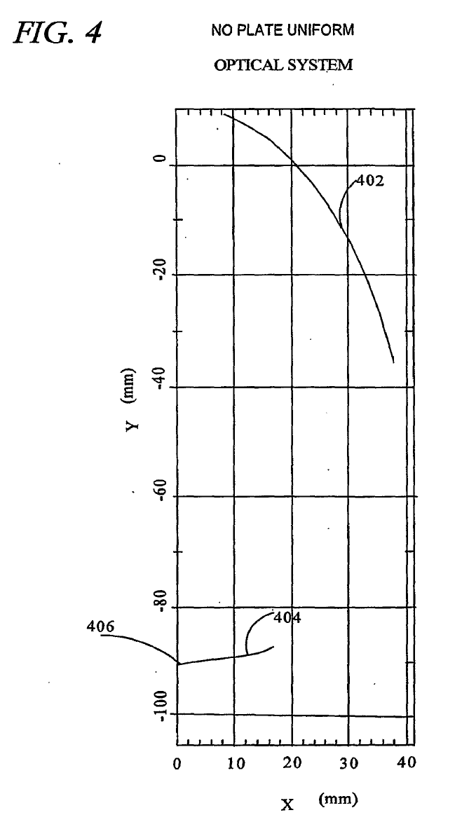

FIG. 4 is a graph including plots of profiles of a first reflector 402 and a first lens 404 according to an embodiment of the invention. The profiles of the first reflector 402 and the first lens 404 shown in FIG. 4 are solutions of the system of differential equations. Note that the lens includes a central reentrant peak 406. The initial conditions and other design parameters associated with the first reflector 402 and first lens 404 shown in FIG. 4 are given in Table I.

TABLE I
(NO WINDOW UNIFORM)

| | |
|---|---|
| φ₀ | −0.750 radians |
| φ_{Ω} | 0.806 radians |
| r(φ₀) | 51.452 mm |
| $\frac{\partial r ( φ )}{\partial φ} {\vert}_{φ = {φ}_{0} }$ | −74.698 |
| Yr(φ₀) | −87.232 mm |
| YFO | −93.282 mm |
| YT | −94.282 |
| Xmax | 16.5 mm |
| Xmin | 0.0 mm |
| Cos(φ)Rad(φ) | FIG. 2: |
| Irr(Xt) | =1 (UNIFORM) |
| F | 1.04346 |
| Nlens | 1.5 |
| DIST sign | + |
| X₀ | Xmax |

In table I YFO is the Y coordinate of the bottom surface 310 of the first lens 404 and YT is the Y coordinate of the illuminated plane 306 illuminated by the first reflector and first lens. YFO and YT are not variables in equations 1 and 2, but are used in ray trace evaluation of first lens and first reflector. Note that the diameter of the illuminated area 2*Xmax is equal to the diagonal of a 1.3″ (33 mm) liquid crystal image modulator. A constant reflectance of 1.0 was assumed. Note that if r_{R}(θᵢ_{_{—}}_{R}) is assumed to be constant, the actual value of the constant (e.g., 0.95 or 1.0) has no bearing on the profiles of the luminaire optics. In practice if the variation of reflectivity of the reflector material varies with angle is not negligible, it is best to base r_{R}(θᵢ_{_{—}}_{R}) on actual measurements, although a closed form expressions may be available for certain materials.

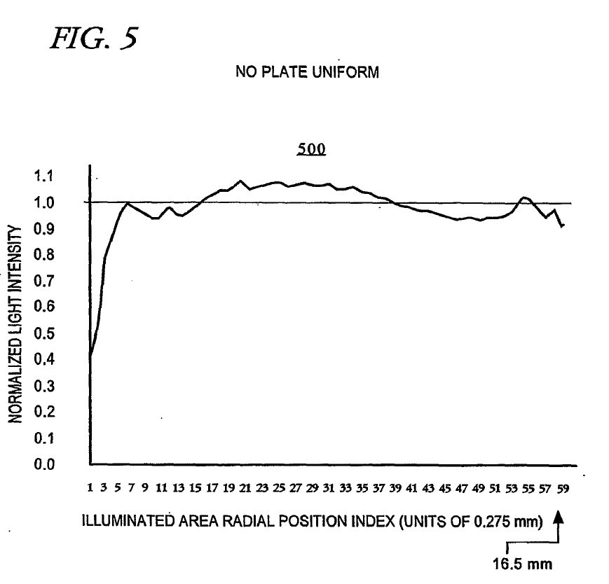

FIG. 5 is a plot 500 of light intensity verses radial position that is produced by a luminaire when using the first reflector 402 and the first lens 404 having the profiles shown in FIG. 4 with the compact arc lamp 100 having the cosine weighted luminance shown in FIG. 2. The illuminance profile shown in FIG. 5 was determined by ray tracing rays generated from the above mentioned ProSource™ light source model. As shown in FIG. 5 the light intensity closely matches the specified uniform intensity distribution Irr(Xt)=1. The average absolute value deviation from the specified distribution is 6.3%. (Note in calculating this figure equal weight was given to the deviation at each radius, (as opposed to weighting by annulus area) so as not to de-emphasize the effect of deviations closer to the optical axis). The deviation is most pronounced near the center of the illuminated area, however the area in which the deviation occurs is a small percentage of the total area of the illuminated area. The distribution can be made more uniform with a diffuser, preferably a low angle diffuser that does not substantially degrade collimation. Alternatively, a short, frustoconical reflector may be added at the top of the reflector to boost the intensity at the center of the illuminated area. Assuming that both surfaces of the lens 404 were uncoated, and assuming 95% reflectance of the first reflector 402 yields a collection efficiency of 77.9%. Antireflection coating of the lens 404 can improve this figure at some expense.

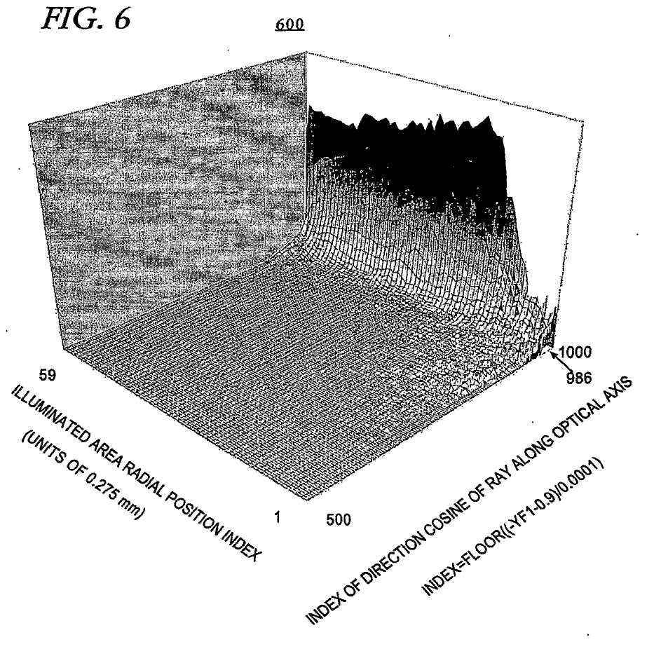

FIG. 6 is a surface plot 600 that shows light intensity plotted against radial position and against an index related to the magnitude of a component of ray vectors parallel to the optical axis (Y-axis) when using the first reflector 402 and first lens 404 having the profiles shown in FIG. 4 with the compact arc lamp 100 having the cosine weighted luminance shown in FIG. 2. The index related to the magnitude of the component parallel to the optical axis is given by INDEX=FLOOR((−YF1−0.9)/0.0001) where YF1 is the ray component parallel to the optical axis (Y-axis) and FLOOR is a function that converts a real number value to the greatest integer less than the real number. FIG. 6 conveys in fine detail what is commonly summarized by the figure of merit for illumination optics known as étendue. Index 986 shown on the graph corresponds to the average angle of incidence (angle relative to the Y axis) which is 3.06 degrees—a relatively low value. Thus, the reflector 402 and lens 404 achieve a high degree of collimation.

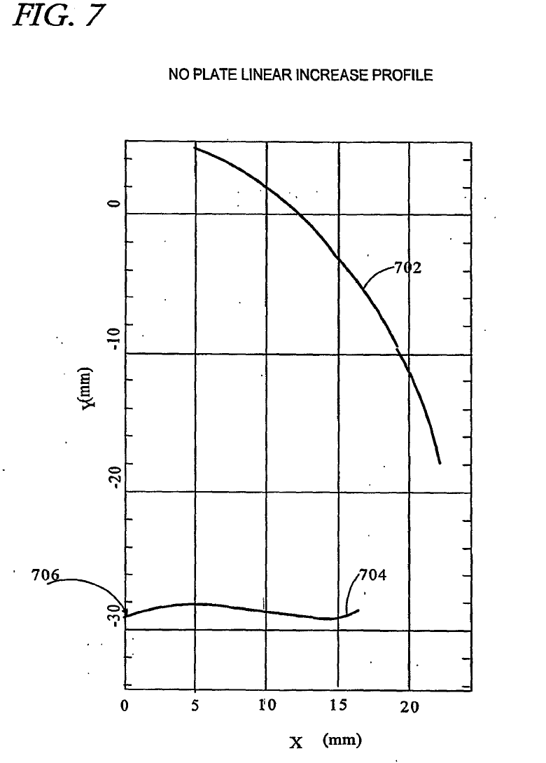

FIG. 7 is a graph including plots of profiles of a second reflector 702 and a second lens 704 according to an embodiment of the invention. The profiles of the second reflector 702 and the second lens 704 shown in FIG. 7 are given by the system of differential equations 1 and 2. Note the mustache shape of the lens 704 and the reentrant peak 706. The initial conditions and other design parameters associated with the first reflector 702 and second reflector 704 shown in FIG. 7 are given in Table II.

TABLE II
(NO WINDOW LINEAR INCREASE)

| | |
|---|---|
| φ₀ | −0.678 radians |
| φ_{Ω} | 0.759 radians |
| r(φ₀) | 28.377 mm |
| $\frac{\partial r ( φ )}{\partial φ} {\vert}_{φ = {φ}_{0} }$ | −34.711 |
| Yr(φ₀) | −28.607 mm |
| YFO | −32.092 mm |
| YT | −33.092 mm |
| Xmax | XMAX = 16.5 mm |
| Xmin | 0.0 mm |
| Cos(φ)Rad(φ) | FIG. 2 |
| Irr(Xt) | =0.1 + (Xt/Xmax)*0.9 |
| F = | 1.04349445684524 |
| Nlens | 1.5 |
| DIST sign | + |
| X₀ | Xmax |

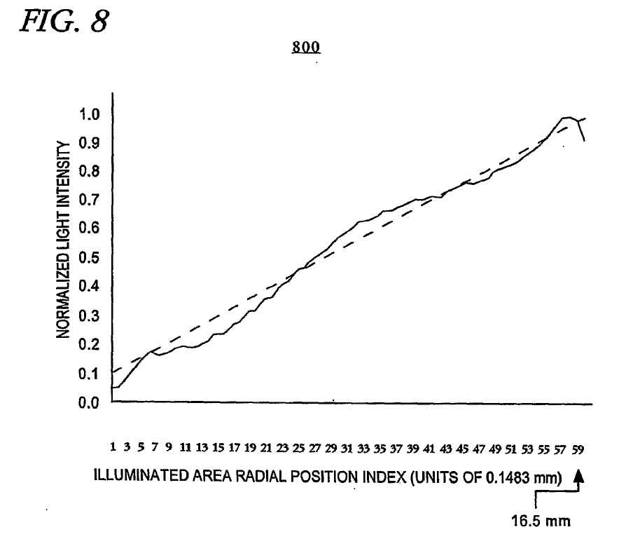

FIG. 8 is a plot 800 of light intensity versus radial position that is produced by a luminaire using the second reflector 702 and the second lens 704 having the profiles shown in FIG. 7 with the compact arc lamp having the cosine weighted radiance shown in FIG. 2. The illuminance profile shown in FIG. 7 was determined by ray tracing rays generated from the above mentioned ProSource™ light source model. As shown in FIG. 7 the light intensity closely matches the specified intensity distribution Irr(Xt)=0.1+(Xt/Xmax)*0.9. The average absolute value deviation from the specified distribution is 2.7%. Assuming that both surfaces of the second lens 704 are uncoated, and assuming 95% reflectance of the second reflector 702 yields a collection efficiency of 74.5%. Antireflection coating of the lens 704 can improve this figure at some expense. The average angle of incidence of light on the illuminated area has a relatively low value of 3.05 degrees.

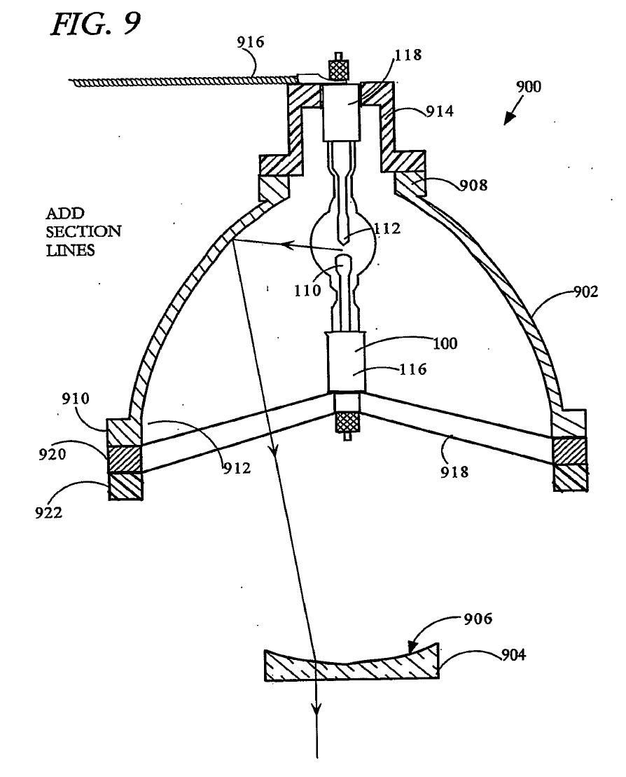

FIG. 9 is a cross-sectional side view of a luminaire 900 and including an associated lens 904 according to an embodiment of the invention. Although not shown in FIG. 9 the lens 904 can be attached to the luminaire. As shown in FIG. 9, the luminaire 900 comprises the arc lamp 100, which is positioned on an axis of rotational symmetry of a reflector 902. The lens 904 comprises a surface 906 that faces the reflector 902. The profiles of the reflector 902 and surface 906 of the lens 904 are defined by the differential equations 1 and 2. The reflector 902 includes a back flange 908 and a front flange 910. Light reflected by the reflector 902 exits through an opening 912 (encircled by the front flange 910). A lamp support 914 is coupled to the back flange 908. The lamp support 914 can be coupled to the back flange 908 by various methods or can be formed integrally with the back flange 908. The lamp support 914 serves to support the arc lamp 100 relative to the reflector 902. Alternatively, a mechanism for adjusting the position of the arc lamp relative to the reflector is provided. Such a mechanism may be useful for adjusting the position of lamps if asymmetric erosion of the electrodes occurs. The lamp support 914 may also serve as a heat sink for the lamp. The lamp support 914 can be affixed to the arc lamp by various methods. A cathode lead 916 is coupled to the cathode terminal 118 and a plurality of flat reflective, conductive supports 918 are coupled to the anode terminal 116. The conductive supports 918 extend radially to a conductive ring 920 that is clamped to the front flange 910 by an insulating ring 922 and insulating fasteners (not shown) The details of the mechanical arrangement can vary widely from what is shown in FIG. 9 and are not the focus of the invention. The lens 904 could be attached to the reflector 902 by a separate part (not shown) or supported independently of the reflector 902.

Note that although in the luminaire 900 as shown in FIG. 9 the anode 110 is on the side of the front flange 910, alternatively the orientation of the lamp 100 is reversed such that the cathode 112 is on the side of front flange 910.

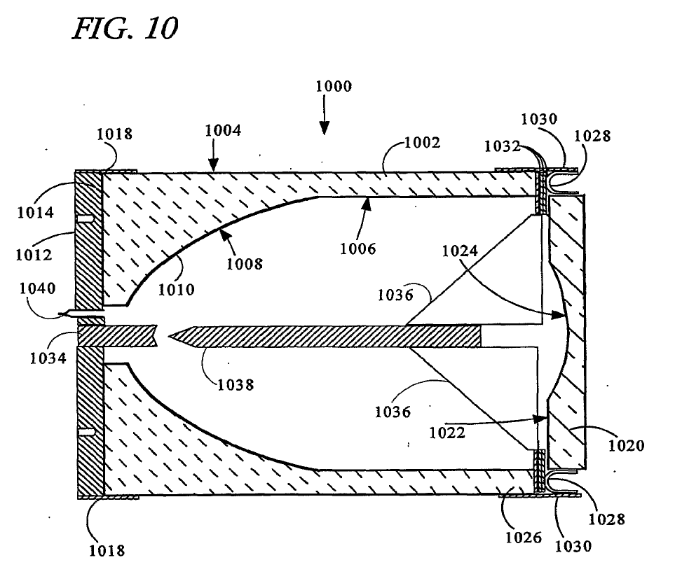

FIG. 10 is cross-sectional side view of a reflectorized discharge envelope integrated luminaire 1000 according to an embodiment of the invention. The luminaire 1000 includes a ceramic body 1002. An outside surface 1004 of the ceramic body 1002 is cylindrical and an inside surface 1006 of the ceramic body 1002 includes a rear portion 1008 formed in the shape of a rotationally symmetric reflector described by equation 1. (Alternatively the inside surface 1006 of the ceramic body 1002 is cylindrical and a separate reflector is mounted inside the ceramic body 1002.) A reflective coating 1010 is suitably formed on the rear portion 1008 of the inside surface 1006. An anode support/heat sink 1012 abuts a back end 1014 of the ceramic body 1002. The anode support/heat sink 1012 is coupled to the ceramic body 1002 by a first sleeve 1018 that is located peripherally about the back end 1014 of the ceramic body 1002 and the anode support/heat sink 1012. The first sleeve 1018 is suitably Tungsten Inert Gas (TIG) welded to the anode support/heat sink 1012 and brazed to ceramic body 1002.

A window 1020 having an inside surface 1022 including a central lens portion 1024 that has a profile parametrically defined by equation 2 and equation 4 is fitted at a front end 1026 of the ceramic body 1002. The window 1020 is attached to the ceramic body 1002 by a flange 1028, second sleeve 1030 and a set of spacers 1032. The set of spacers 1032 are suitably brazed to each other and to the flange 1028. The flange 1028 is suitably TIG welded to the second sleeve 1030 which is brazed to the ceramic body 1002. The window 1020 is suitably brazed to the flange 1028. According to an alternative embodiment the window 1020 is fused silica or other glass and the flange 1028 is embedded in the periphery of the window 1020 forming a glass to metal seal.

An anode 1034 is supported by the anode support/heat sink 1012. A plurality of cathode support arms 1036 extend radially inward from one or more of the set of spacers 1032 to a centrally located cathode 1038. The anode 1034 and cathode 1038 are arranged on an axis of rotational symmetry of the rear reflector shaped portion 1008 of the inside surface 1006.

A tube 1040 fitted into the anode support/heat sink 1012 allows the luminaire 1000 to be evacuated and filled with a discharge fill such as xenon gas.

Construction details can vary considerably from the particular design shown. For example, a copper body can be used in lieu of ceramic. Also, the reflector can be separate part positioned within the body. In each case, the luminaire optics described herein may be used.

In the case of integrated luminaries there is no bare lamp that can be measured, to obtain the radiance data Rad(φ) for used in equations 1 and 2. A procedure that may be used to obtain the Rad(φ) is to measure the near field radiance in front of the window of an integrated luminaire that has a traditional elliptical or parabolic reflector and then use backward ray tracing to trace rays that have energies derived from the measured near field radiance back beyond points of reflection by the traditional reflector, then to trace the rays to an imaginary reference sphere (e.g., a sphere of diameter one meter) and to bin the rays according to elevation angle at the larger sphere. After ray energies have been binned by elevation angle, a interpolant representing Rad(φ), e.g., a cubic spline interpolant can be fitted to the binned data.

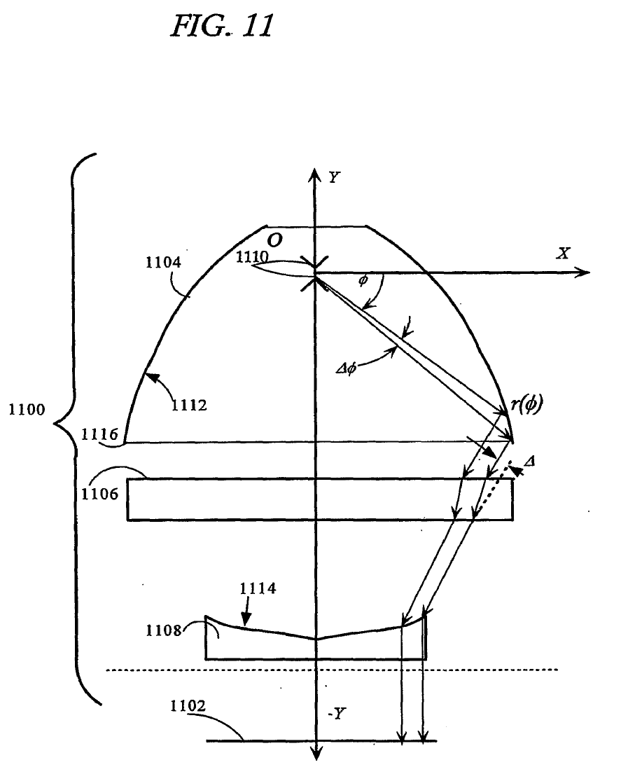

FIG. 11 is a schematic diagram of luminaire optics 1100 for illuminating an illuminated area 1102 with collimated light according to certain embodiments of the invention. The luminaire optics 1100 comprise a reflector 1104, a transparent window 1106, and a lens 1108. A light source 1110 (e.g., lamp 100), represented by opposed chevrons, is positioned within the reflector 1104. A substantial portion of light emitted by the light source 1110 is reflected by a reflective surface 1112 of the reflector 1104 to a first surface 1114 of the lens 1108 that faces the reflector 1104. In traversing from the reflective surface 1112 to the first surface 1114 of the lens 1108, the light passes through a transparent window 1106. For practical reasons it is often desirable to locate the transparent window (e.g. 1106,) in front of a reflector (e.g., 1104) of a luminaire. One reason is to contain fragments in the event that a discharge type light source (e.g., 100) fails explosively. Another reason is to form a sealed environment within the reflector (e.g., 1104) that protects the reflective surface (e.g., 1112) of the reflector (e.g., 1104) and light source (e.g., 100) from humidity and dust. Another reason is interpose a polarization or wavelength selective transmitter (e.g., heat and/or ultraviolet absorbing glass) into an optical system that includes the luminaire optics 1100, as close as possible to the light source 1110, so as to protect optical elements in the system (e.g., the lens 1108) from damage. Although as shown in FIG. 11, the transparent window 1106 is displaced from the reflector 1104, the window 1106 is alternatively located over a front aperture 1116 of the reflector 1202. Alternatively, a cylindrical housing part (not shown) is positioned between the transparent window 1106 and the front aperture 1116.

Reflectors defined by equation 1 will, in general, reflect most rays to lens at angles. (There may be a subset of rays that do reach the lens at normal incidence.) As shown in FIG. 11, rays passing through the transparent window 1106 at an angle will be offset by certain distance (denoted Δ) from their original path. Thus, if a transparent window (e.g., 1106) is used with reflectors conforming to equation 1, the irradiance profile Irr(x) will be disturbed. The degree of disturbance depends on the magnitude of the offsetting of rays which depends on the thickness and index of refraction of the transparent window 1106 and on the angle of incidence of light rays on the transparent window 1106. Generally, a difference between the size of the aperture 1116 and the illuminated area diameter Xmax leads to rays passing through the transparent window 1106 at larger angles.

In certain cases it may be desirable to include two or more transparent windows having different indices of refraction between the reflector 1104 and the lens 1108.

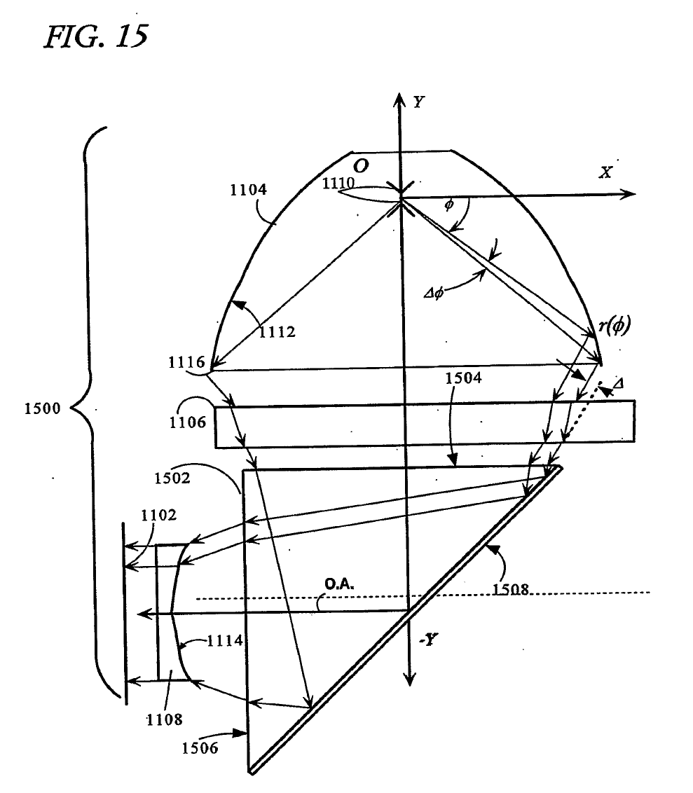

Equation 7, equation 8 and equation 9 given below in combination with equation 1 define profiles of the reflector 1104 and the lens 1108, and more generally describe a type of luminaire optics in which one or more with transparent objects (e.g., windows, prisms) are interposed between the reflector and lens. The luminaire optics described by equations 1, 7, 8 and 9 are able to illuminate annular or circular areas with light intensity distributions that closely approximate desired, specified light intensity distributions. The transparent window 1106 or a plurality of transparent windows is a simple example of the aforementioned transparent objects. A prism that has an entrance face and an exit face, and one or more reflective faces is another example of a transparent object. An embodiment with a prism is described below with reference to FIG. 15. A liquid filled cell enclosing water or another fluid with a spectrally selective absorbance that may be used to filter out ultraviolet or infrared or for some other purpose is another example of transparent objects. The index of the windows of the cell may differ from the index of the liquid, such that each would be treated as a separate object.

$$\text{(REFLECTOR EQUATION)} \qquad \qquad EQU . 7$$

$$\frac{{\partial }^{2}}{\partial {φ}^{2}} r ( φ ) = - ( ( \frac{cos ( φ - 2 arc tan ( \frac{\frac{\partial }{\partial φ} r ( φ )}{r ( φ )} ) ) F DIST}{sin ( φ - 2 arc tan ( \frac{\frac{\partial }{\partial φ} r ( φ )}{r ( φ )} ) ) - Nlens} - ( \frac{\partial }{\partial φ} r ( φ ) ) sin ( φ ) - r ( φ ) cos ( φ ) + ( 1 + {tan ( φ - 2 arc tan ( \frac{\frac{\partial }{\partial φ} r ( φ )}{r ( φ )} ) )}^{2} ) ( 1 + 2 \frac{{( \frac{\frac{\partial }{\partial φ} r ( φ )}{r ( φ )} )}^{2}}{{r ( φ )}^{2} ( 1 + \frac{{( \frac{\frac{\partial }{\partial φ} r ( φ )}{r ( φ )} )}^{2}}{{r ( φ )}^{2}} )} ) r ( φ ) cos ( φ ) + tan ( φ - 2 arc tan ( \frac{\frac{\partial }{\partial φ} r ( φ )}{r ( φ )} ) ) ( \frac{\partial }{\partial φ} r ( φ ) ) cos ( φ ) - tan ( φ - 2 arctan ( \frac{\frac{\partial }{\partial φ} r ( φ )}{r ( φ )} ) ) r ( φ ) sin ( φ ) ) / tan ( φ - 2 arc tan ( \frac{\frac{\partial }{\partial φ} r ( φ )}{r ( φ )} ) ) +$$

$$( - 1 - {cot ( φ - 2 arc tan ( \frac{\frac{\partial }{\partial φ} r ( φ )}{r ( φ )} ) )}^{2} ) ( 1 + 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} ) ( {\sum }_{n = 1}^{N} {th}_{n} ) - ( ( Yr ( φ ) - r ( φ ) sin ( φ ) + tan ( φ - 2 arc tan ( \frac{\frac{\partial }{\partial φ} r ( φ )}{r ( φ )} ) ) r ( φ ) cos ( φ ) ) ( 1 + {tan ( φ - 2 arc tan ( \frac{\frac{\partial }{\partial φ} r ( φ )}{r ( φ )} ) )}^{2} ) ( 1 + 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} ) ) / {tan ( φ - 2 arc tan ( \frac{\frac{\partial }{\partial φ} r ( φ )}{r ( φ )} ) )}^{2} + F DIST +$$

$$( {\sum }_{n = 1}^{N} ( \frac{\begin{matrix}{th}_{n} no sin ( φ - 2 arc tan ( \frac{\frac{\partial }{\partial φ} r ( φ )}{r ( φ )} ) ) \\ ( 1 + 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} )\end{matrix}}{\sqrt[{np}_{n}]{1 - \frac{{no}^{2} {cos ( φ - 2 arc tan ( \frac{\frac{\partial }{\partial φ} r ( φ )}{r ( φ )} ) )}^{2}}{{np}_{n}^{2}}}} + \frac{\begin{matrix}{th}_{n} {n }^{3} {cos ( φ - {2}^{1} arc tan ( \frac{\frac{\partial }{\partial φ} r ( φ )}{r ( φ )} ) )}^{2} \\ sin ( φ - 2 arc tan ( \frac{\frac{\partial }{\partial φ} r ( φ )}{r ( φ )} ) ) \\ ( 1 + 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} )\end{matrix}}{{{np}_{n}^{3} ( 1 - \frac{{no}^{2} {cos ( φ - 2 arc tan ( \frac{\frac{\partial }{\partial φ} r ( φ )}{r ( φ )} ) )}^{2}}{{np}_{n}^{2}} )}^{( \frac{3}{2} )}} ) ) ) /$$

$$( - 2 \frac{( 1 + {tan ( φ - 2 arc tan ( \frac{\frac{\partial }{\partial φ} r ( φ )}{r ( φ )} ) )}^{2} ) cos ( φ )}{( 1 + \frac{{( \frac{\partial }{\partial φ} r ( φ ) )}^{2}}{{r ( φ )}^{2}} ) tan ( φ - 2 arc tan ( \frac{\frac{\partial }{\partial φ} r ( φ )}{r ( φ )} ) )} - 2 \frac{( - 1 - {cot ( φ - 2 arc tan ( \frac{\frac{\partial }{\partial φ} r ( φ )}{r ( φ )} ) )}^{2} ) ( {\sum }_{n = 1}^{N} {th}_{n} )}{r ( φ ) ( 1 + \frac{{( \frac{\partial }{\partial φ} r ( φ ) )}^{2}}{{r ( φ )}^{2}} )} + 2 \frac{\begin{matrix}( Yr ( φ ) - r ( φ ) sin ( φ ) + tan ( φ - 2 arc tan ( \frac{\frac{\partial }{\partial φ} r ( φ )}{r ( φ )} ) ) r ( φ ) cos ( φ ) ) \\ ( 1 + {tan ( φ - 2 arc tan ( \frac{\frac{\partial }{\partial φ} r ( φ )}{r ( φ )} ) )}^{2} )\end{matrix}}{{tan ( φ - 2 arc tan ( \frac{\frac{\partial }{\partial φ} r ( φ )}{r ( φ )} ) )}^{2} r ( φ ) ( 1 + \frac{{( \frac{\partial }{\partial φ} r ( φ ) )}^{2}}{{r ( φ )}^{2}} )} +$$

$$( {\sum }_{n = 1}^{N} ( - 2 \frac{{th}_{n} no sin ( φ - 2 arc tan ( \frac{\frac{\partial }{\partial φ} r ( φ )}{r ( φ )} ) )}{\begin{matrix}{np}_{n} r ( φ ) ( 1 + \frac{{( \frac{\partial }{\partial φ} r ( φ ) )}^{2}}{{r ( φ )}^{2}} ) \\ \sqrt{1 - \frac{{no}^{2} {cos ( φ - 2 arc tan ( \frac{\frac{\partial }{\partial φ} r ( φ )}{r ( φ )} ) )}^{2}}{{np}_{n}^{2}}}\end{matrix}} - 2 \frac{{th}_{n} {no}^{3} {cos ( φ - 2 arc tan ( \frac{\frac{\partial }{\partial φ} r ( φ )}{r ( φ )} ) )}^{2} sin ( φ - 2 arc tan ( \frac{\frac{\partial }{\partial φ} r ( φ )}{r ( φ )} ) )}{\begin{matrix}{{np}_{n}^{3} ( 1 - \frac{{no}^{2} {cos ( φ - 2 arc tan ( \frac{\frac{\partial }{\partial φ} r ( φ )}{r ( φ )} ) )}^{2}}{{np}_{n}^{2}} )}^{( \frac{3}{2} )} \\ r ( φ ) ( 1 + \frac{{( \frac{\partial }{\partial φ} r ( φ ) )}^{2}}{r ( φ )} )\end{matrix}} ) ) )$$

where, capital N is the number of transparent objects (e.g., transparent windows or prisms) positioned between the reflector and lens described by equations 1, 6, 7 and 8;

lower case n is an index that refers to the individual transparent objects;

no is an index of refraction in the environment of the luminaire (e.g., nominally 1.0 for air)

thₙ is the thickness (measured along the optical axis) of the n^{th} transparent object (e.g., window 1208),

npₙ is the index of refraction of the n^{th} transparent object;

$$DIST = \pm \frac{\begin{matrix}2 π cos ( φ ) \cdot ( {\prod }_{n = 1}^{N} {t}_{n} ( {θ}_{i\_n} ) ) \cdot \\ {r}_{R} ( {θ}_{i\_R} ) \cdot {t}_{L} ( {θ}_{i\_L} ) Rad ( φ )\end{matrix}}{2 π Xt ( φ ) \cdot Irr ( Xt )} \frac{{\int }_{{X}_{MIN}}^{{X}_{MAX}} Xt \cdot Irr ( Xt ) d x}{{\int }_{{φ}_{0}}^{{φ}_{Ω}} cos ( φ ) \cdot Rad ( φ ) d φ} \qquad EQU . 8$$

where, θᵢ_{_{—}}ₙ is the angle of incidence of on the nth transparent object;
tₙ(θᵢ_{_{—}}ₙ) is the transmittance of the n^{th} transparent object; and
other variables, with the exception of the expression for Xt which appears in DIST, are the same as defined above in reference to equation 1.
   The expression for Xt for use in DIST in equation 1, 6 and 7 in the case that one or more transparent objects are interposed between the reflector and lens is given by equation 9.

$$Xt := \frac{\begin{matrix}Yr ( φ ) - r ( φ ) sin ( φ ) + \\ tan ( φ - 2 arctan ( \frac{\frac{\partial }{\partial φ} r ( φ )}{r ( φ )} ) ) r ( φ ) cos ( φ )\end{matrix}}{tan ( φ - 2 arctan ( \frac{\frac{\partial }{\partial φ} r ( φ )}{r ( φ )} ) )} + ( {\sum }_{n = 1}^{N} ( - \frac{{th}_{n} no cos ( φ - 2 arctan ( \frac{\frac{\partial }{\partial φ} r ( φ )}{r ( φ )} ) )}{{np}_{n} \sqrt{1 - \frac{{no}^{2} {cos ( φ - 2 arctan ( \frac{\frac{\partial }{\partial φ} r ( φ )}{r ( φ )} ) )}^{2}}{{np}_{n}^{2}}}} ) ) + cot ( φ - 2 arctan ( \frac{\frac{\partial }{\partial φ} r ( φ )}{r ( φ )} ) ) ( {\sum }_{n = 1}^{N} {th}_{n} ) \qquad EQU . 9$$

For use in integrating equations 1, 7, 8, and 9, the angle of incidence on each transparent object θᵢ_{_{—}}ₙ, is suitably expressed in terms of the independent variable φ, polar radial coordinate r(φ), and the derivative of the polar radial coordinate ∂r/∂φ. The angle of rays reflected by the reflector relative the Y-axis (the optical axis) is given by:

$$\begin{matrix}{θ}_{RR} = abs ( \frac{π}{2} - φ + 2 arctan ( \frac{1}{r} \frac{\partial r}{\partial φ} ) ) & EQU . 10\end{matrix} \qquad$$

If light is incident on a transparent object from air and the surface of the transparent object is arranged perpendicular to the optical axis of the reflector (Y-axis) then the angle of incidence on the transparent object θᵢ_{_{—}}ₙ is equal to θ_{RR}. If light is incident on a n^{th} transparent object from a preceding, abutting (n−1)^{th} transparent object, then angle of incidence on the nth transparent object denoted θᵢ_{_{—}}ₙ is according to Snell's law given by:

$${θ}_{i\_n} = arcsin ( \frac{no}{{np}_{n - 1}} sin ( {θ}_{RR} ) ) \qquad EQU . 11$$

where, npₙ₋₁ is the index of refraction of the (n−1)^{th} transparent object. If multiple transparent objects are cemented together with optical cement, the reflectance of light passing between the multiple transparent object may be negligible. For an uncoated glass window Fresnel transmission formulas are used for tₙ(θᵢ_{_{—}}ₙ). If one or more of the transparent objects are coated with single of multiplayer interference coatings known equations for transmittance given, for example, in A. Thelen “Design of Optical Interference Coatings” McGraw Hill 1989 can be used for tₙ(θᵢ_{_{—}}ₙ). In cases in which tₙ(θᵢ_{_{—}}ₙ) is not readily calculable, measurements of tₙ(θᵢ_{_{—}}ₙ) can be made and fitted to function or spline interpolant for use in DIST.

Note that DIST defined by equation 8 is to be used in equation 1 when equation 1 is used in combination with equation 7 to specify luminaire optics of the general type shown in FIG. 11 that include one or more transparent objects between the reflector and lens.

In the case of luminaire optics described by equation 1, 7-11, F not only compensates for light toss at the reflector and lens, but also light loss at the one or more transparent objects. In this case F is approximately equal to the inverse of the product of the average reflectance of the reflector, average transmittance of the lens, and average transmittance of the one or more transparent objects. A more precise value of F is determined as previously indicated, but using the form of Xt given in equation 9.

Once the initial value of the independent variable φ₀, the initial radial coordinate r(φ₀) and the initial Y coordinate of the lens Yr(φ₀) have been chosen, in order to completely specify the initial conditions, the initial value of the derivative of the polar radial coordinate of the generatrix with respect to elevation angle:

$${\frac{\partial r ( φ )}{\partial φ} \vert}_{φ = {φ}_{0}}$$

must be determined.

Because the one or more transparent object located between the reflectors and lenses of the type described by equations 1, 7, 8 and 9, cause rays to be offset, equation 5 does not give the correct value for the initial value of the preceding derivative. One approach to calculating the initial value of the derivate, is to substitute chosen numerical values for the quantities φ₀, r(φ₀), Yr(φ₀), X₀, thₙ, npₙ, appearing in equation 9 and then numerically solve equation 9 for the initial value of the derivative of the polar radial coordinate. The bisection method is one method that can be used to numerically solve equation 9 for the initial value of the derivative.

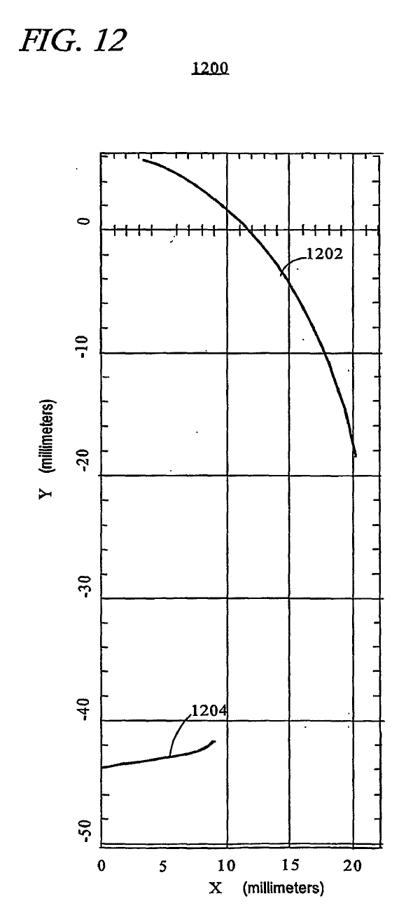

FIG. 12 is a graph 1200 including plots of profiles of a third reflector 1202 and third lens 1204 according to an embodiment of the invention. The lens profile is for an upper surface that faces the reflector. The profile of the third reflector 1202 and third lens 1204 are specified by equations 1, 7, 8 and 9. The third reflector 1202 and third lens 1204 are designed to work with a transparent window (not shown in FIG. 12) interposed between them. The initial conditions and other design parameters associated with the third reflector 1202 and third lens 1204 shown in FIG. 12 are given in Table III.

TABLE III
(WITH WINDOW, UNIFORM)

| | |
|---|---|
| φ₀ | −0.737 radians |
| φ_{Ω} | 1.012 radians |
| r(φ₀) | 27.147 mm |
| $\frac{\partial r ( φ )}{\partial φ} {\vert}_{φ = {φ}_{0} }$ | −35.312 |
| Yr(φ₀) | −41.839 mm |
| YFO | −46.760 mm |
| YT | −47.760 mm |
| Xmax | 8.9 mm |
| Xmin | 0.0 mm |
| Cos(φ)Rad(φ) | FIG. 2 |
| Irr(Xt) | =1 (UNIFORM) |
| F | 1.1356 |
| N | 1 TRANSPARENT OBJECT |
| th₁ | 5 mm |
| np₁ | 1.5 |
| no | 1.0 |
| Nlens | 1.5 |
| DIST sign | + |
| Xo | Xmax |

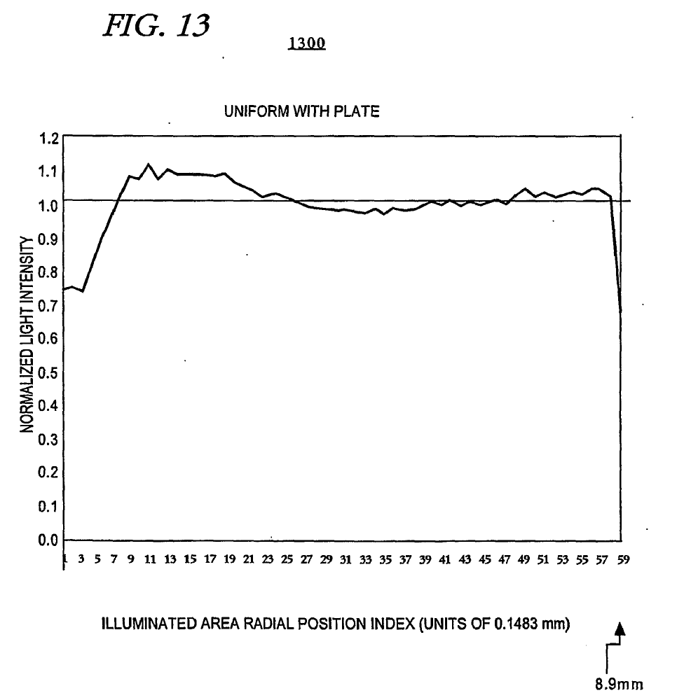

FIG. 13 is a plot 1300 of light intensity versus radial position that is produced by a luminaire using the third reflector 1202 and the third lens 1204 with the compact arc lamp having the cosine weighted luminance shown in FIG. 2. The illuminance profile shown in FIG. 13 was determined by ray tracing rays generated from the above mentioned ProSource™ light source model. As shown in FIG. 13 the light intensity closely matches the specified uniform intensity distribution Irr(Xt)=1. The average absolute value deviation from the specified distribution is 5.8%. The deviation is most pronounced near the center of the illuminated area, and in a small width annulus at the periphery of the illuminated area. However, the area in which the deviation occurs is a small percentage of the total area of the illuminated area. The distribution can be made more uniform with a diffuser, preferably a low angle diffuser that does not substantially degrade collimation. In addition, Xmax can be set to a slightly higher value than is actually need to avoid the drop off in intensity at the periphery. Assuming that both surfaces of the lens 1204, and both surfaces of the transparent window were uncoated and assuming 95% reflectance of the first reflector 402, yields a collection efficiency of about 67%. Antireflection coating the surfaces of the transparent window and the bottom surface of the lens can improve this figure by about 1.04 cubed, yielding and collection efficiency of 75%.

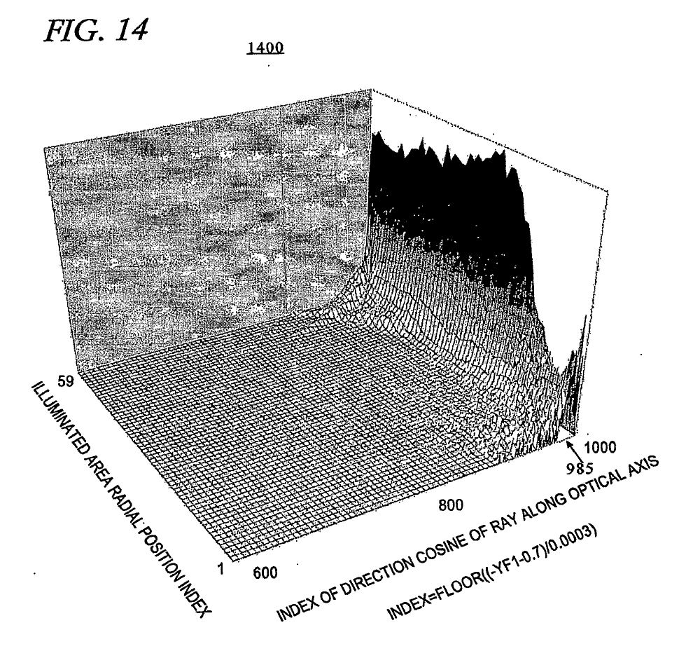

FIG. 14 is a surface plot 1400 that shows light intensity plotted against radial position and against an index related to the magnitude of a component of ray vectors parallel to the optical axis (Y-axis) when using the third reflector 1202 and third lens 1204 having the profiles shown in FIG. 12 with the compact arc lamp 100 having the cosine weighted luminance shown in FIG. 2. The index related to the magnitude of the component parallel to the optical axis is given by INDEX=FLOOR((−YF1−0.7)/0.0003). FIG. 12 conveys in fine detail what is commonly summarized by the figure of merit for illumination optics known as étendue. Index value 985 corresponds to the average angle of incidence (equal to the angle from the Y-axis) which has a relatively low value of 5.3 degrees. Thus, the reflector 1202 and lens 1204 achieve a relatively high degree of collimation.

Thus, the reflector 1202 and lens 1204 are able to collect a substantial portion of light emitted by the compact arc lamp 100 (67%) and to illuminate a circular area having a relatively small diameter (17.8 millimeters) relatively uniformly (average deviation 5.8%) with highly collimated light (average angle of incidence 5.3 degrees). The diameter of the illuminated area is equal to the diagonal of a 0.7 inch DLP light modulator chip.

FIG. 15 is a schematic diagram of luminaire optics 1500 according to certain embodiments of the invention. The luminaire optics 1500 are similar to the luminaire optics 1100 shown in FIG. 11, but include an right-angle prism 1502 between the transparent window 1106 and the lens 1108. The prism 1502 includes an entrance face 1504 facing the reflector 1104, an exit face 1506 facing the lens 1108, and a silvered reflective face 1508 tilted at 45 degrees. Note that the prism 1502 also turns the optical axis, labeled O.A., by ninety degrees. The reflective face 1508 can be set at an angle at which total internal reflection (TIR) occurs.

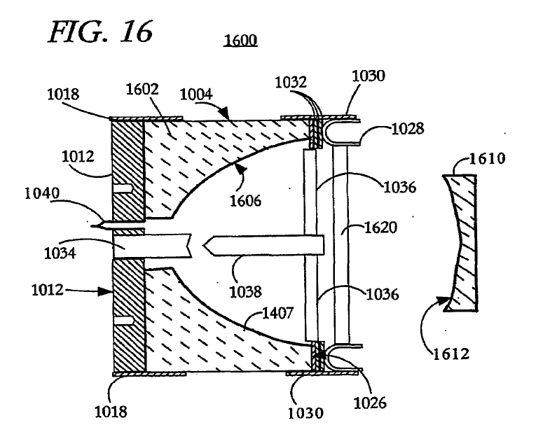

FIG. 16 is a cross-sectional side view of a lens 1610 and a luminaire 1600 according to an embodiment of the invention. The luminaire 1600 is similar in construction to the integrated luminaire 1000 shown in FIG. 10, however, the luminaire 1600 includes a window 1620 with parallel planar surfaces in lieu of the window 1020 with central lens portion 1024 used in the luminaire 1000 shown in FIG. 10. The luminaire 1600 includes a ceramic body 1602 that has a reflector shaped inside surface 1606. The shape of the reflector shaped inside surface 1606 and the shape of a first surface 1612 of the lens 1610 are described by equations 1, 7, 8 and 9 which take into account the index of refraction and thickness of the window 1620. Thus, the embodiment shown in FIG. 16 facilitates the use of a conventional (e.g., sapphire) window, while still obtaining the benefits of high collection efficiency, uniformity and collimation provided by luminaire optics described by equations 1, 7, 8 and 9.

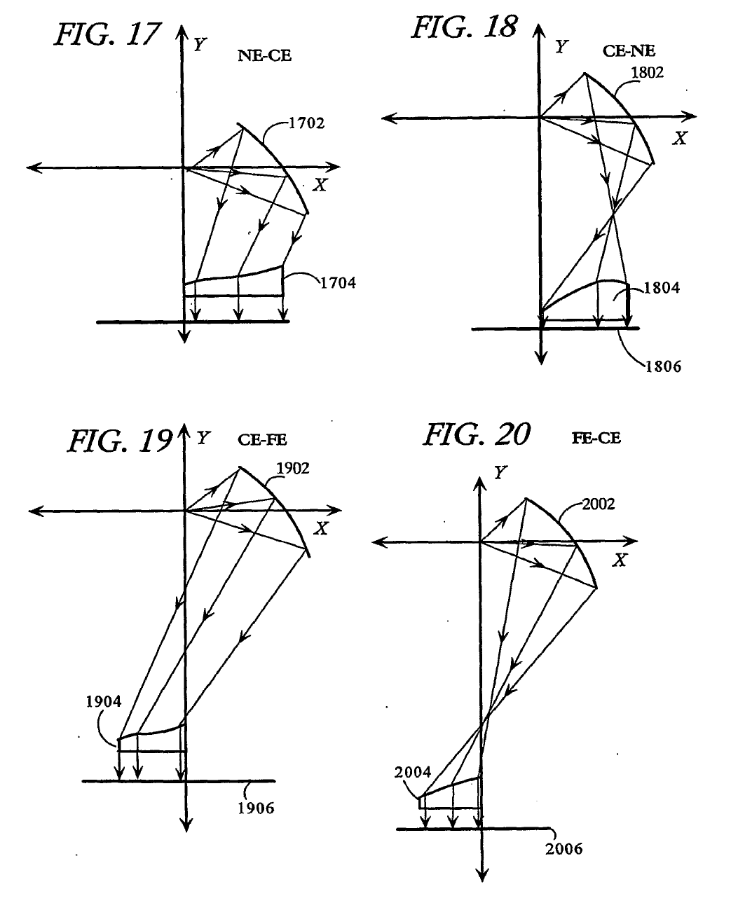

FIG. 17 schematically illustrates the profiles of the luminaire optics, including a reflector 1702, and a lens 1704 of the type shown FIGS. 4, 7, 12 for example. In this type of luminaire optics, a ray emanating from the origin at elevation angle φ₀ is incident at a near edge of the illuminated area (at radius Xmax), and as the elevation angle or rays increase the X coordinate of the ray intercepts with the illuminated area decrease, so that as the elevation angle approaches φ_{Ω} the X coordinate of intercepts of rays with illuminated area approaches zero. In FIGS. 17-20 only generatrices are shown, so that it appears that only one-half of each optic is present.

FIGS. 18-20 show different embodiments of luminaire optics that are obtained from equations 1, 2, 3 and 4 (or alternatively 1, 7, 8, and 9) by changing the sign in front of the expression DIST and/or changing the point on the illuminated area X₀ to which a ray emanating from the origin at elevation angle φ₀ is directed. Although no transparent objects are shown here for clarity, in the case of luminaire optics described by equations 1, 7, 8, 9 there are one or more transparent objects between the reflector and the lens.

FIG. 18 shows a profile of a reflector 1802 and a profile of a lens 1804 of a second type. In this type, X₀ is set to zero (or as discussed above to a small distance e.g., 0.001 mm) and a negative sign is used in front of the expression DIST. In the case of the luminaire optics shown in FIG. 18 an ideal ray emanating from the origin at the elevation angle φ₀ is incident on an illuminated area 1806 at the optical axis (Y-axis) (or at a point removed by the small distance) and as the elevation angle increases the point of incidence moves out to X_{MAX}.

FIG. 19 shows profiles of a reflector 1902 and a lens 1904 of a third type. In this type X₀ is set to zero (or in this case to a distance given by the small negative number e.g., −0.001 mm). Strictly speaking, just considering the mathematical form of DIST a positive sign in front of the DIST subexpression is used to obtain the generatrices of reflector 1902 and lens 1904. However, in as much as the integral in the numerator of DIST is a measurement of power (watts) or lumens, and may be precomputed and stored as a positive value, then one has to consider that for the luminaire optics shown in FIG. 19 Xt appearing in the denominator of DIST will have a negative sign, because rays are reflected across the Y-axis, thus changing the sign of DIST. So, if the integral in the numerator is represented by a positive number, then the leading sign for DIST would be negative in the case of the luminaire optics shown in FIG. 19. In the case of the luminaire optics shown in FIG. 19 a ray emanating from the origin at φ₀ is direct to a central point (Xt=0) on an illuminated area 1906 (or to a point displaced by a small negative distance) and as the elevation angle increase the point at which rays are incident on the illuminated area 1906 moves out to negative Xmax.

FIG. 20 shows a generatrix of a reflector 2002 and a lens 2004 of a fourth type. In the fourth type X₀ is set to negative X_{MAX}. In the case of the luminaire optics shown in FIG. 20, in the same strict sense discussed above, a negative sign is used in front of the DIST expression to obtain the profiles of the luminaire optics 2002, 2004. However, if the integral in the numerator of DIST is precomputed and stored as a positive number, then a positive sign is used in front of DIST to obtain the profiles of the luminaire optics shown in FIG. 20. In the case of the luminaire optics shown in FIG. 20 an ideal ray emanating from the origin at the elevation angle φ₀ is incident on an illuminated area 2006 at minus X_{MAX} and as the elevation angle increases toward φ_{Ω} the point of incidence moves towards X=0.

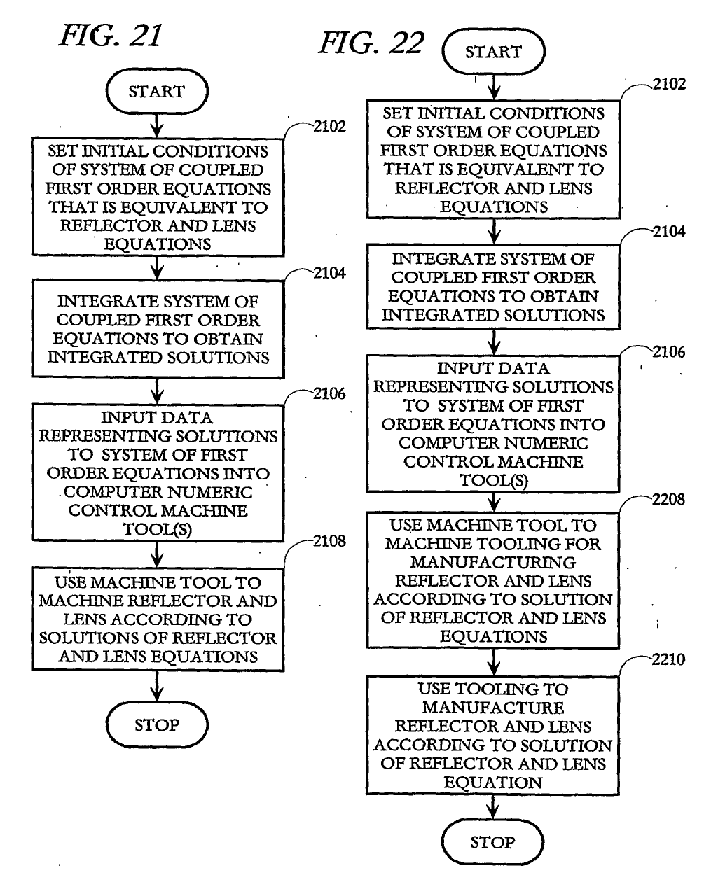

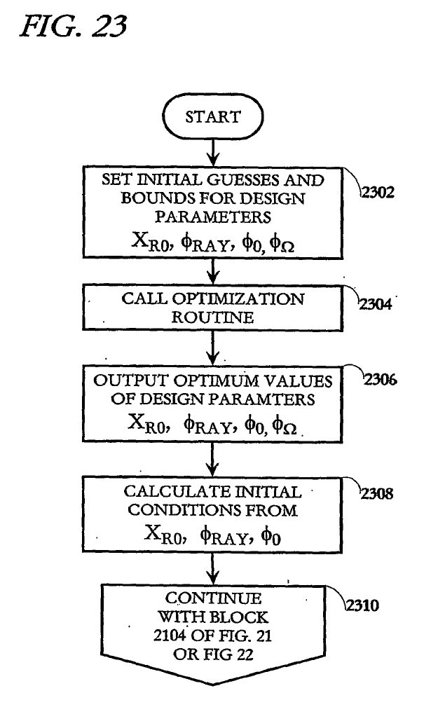

FIG. 21 is a flowchart of a first method 2100 of manufacturing luminaire optics described by equations 1, 2, 3 and 4 or by equations 1, 7, 8 and 9. As indicated above, using equation 6 converts each system of equations into a set of first order coupled differential equations. In block 2102 the initial conditions φ₀, r(φ₀), ∂r(φ)/∂φ(at φ₀), Yr(φ₀) for the equations are set. In block 2104 the system of coupled first order equations is integrated to obtain integrated solutions for a lens profile and a reflector profile. In block 2106 data that represents the integrated solution is entered into one or more computer numeric control (CNC) machine tools (e.g. a CNC lathe) and in block 2108 the CNC machine tool(s) is used to machine a reflector and a lens according to the solution of the integrated solutions of the lens equation and reflector equation. The reflector and lens are machined from blanks or bar stock of selected appropriate material such as metal and optical plastic.

FIG. 22 is a flowchart of a second method 2200 of manufacturing luminaire optics described by equations 1, 2, 3 and 4 or by equations 1, 7, 8 and 9. The first three blocks 2102-2106 in the second method are the same as in the first method 2100. In the second method, after the first three blocks 2102-2106, in block 2208 a machine tool is used to machine tooling for manufacturing a reflector and a lens according to the solution of the reflector and lens equations. The tooling suitably comprises a part of a mold that is used to mold reflectors and lenses and/or a mandrel used to electroform reflectors. In block 2210 the tooling is used to manufacture reflectors and lenses according the solution of the reflector equation and lens equation that was obtained in block 2104. The tooling is suitably machined from metal.

Rather than simply making judicious choices for the φ₀ and φ_{Ω} after reviewing the angular radiance distribution Rad(φ) and making arbitrary choices for the initial lens Y coordinate Yr(φ₀) and initial polar radial coordinate r(φ₀), improved accuracy of the achieved irradiance profile can be achieved by optimizing these design parameters or another set of parameters that determine these parameters. FIG. 23 is a flowchart of an alternative beginning of the first or second methods shown in FIGS. 21-22. The alternative shown in FIG. 23 employs optimization to select design parameters. In block 2302 initial guesses and/or bounds for the design parameters being optimized are set. Although r(φ₀) and Yr(φ₀) can be optimized, the inventor has chosen to use a different set of optimization parameters including X_{RO} and φ_{RAY}. X_{RO} is the cylindrical radial coordinate of the reflector corresponding to the polar radial coordinate (φ₀, r(φ₀)), so that r(φ₀)=X_{RO}/COS(φ₀). φ_{RAY} is the angle that the ray emanating at angle φ₀ and directed to X coordinate X₀ makes with the Y-axis after the ray has been reflected. φ_{RAY} together with φ₀ and r(φ₀) determine Yr(φ₀) by the following equation:

Yr(φ₀)=r(φ₀)*SIN(φ₀)−(r(φ₀)*COS(φ₀)−X₀)/TAN(φ_{RAY}) EQU. 12

Using φ_{RAY} as an optimization parameter allows direct control over, at least the initial value, of the angle of reflected rays relative to the Y-axis angle. In many cases, such as in the integrated profiles shown in FIGS. 4, 7, 12 the initial value angle of reflected rays relative to the Y-axis is the maximum value of the angle of reflected rays relative to the Y-axis. It is generally best to avoid values of φ_{RAY} in excess of about 35 degrees so as to avoid excessive reflection losses from the top surfaces of the lens, however there may be some applications where this can be exceeded.

In addition to X_{RO} and φ_{RAY} the set of parameters that is optimized can include φ₀ and φ_{Ω}. (Alternatively the set of parameters φ₀, φ_{Ω}, r(φ₀) and Yr(φ₀) can be optimized.) The ray tracing can use rays based on near field radiance measurements such as generated by Prosource™ light source models. The camera used to collect such measurements may not be centered exactly on the center of luminance, resulting in a Y-axis offset between the origin of the coordinate system in which the rays are defined and the center of luminance. (The center of luminance may not be known before measurements are taken.) Accordingly, a fifth optimization parameter that can be added is a Y coordinate shift, denoted ΔY_ray that is added to all ray origins used in ray tracing.

Certain optimization routines may require only bounds and certain optimization routines may require only initial guesses. In block 2304 an optimization routine is called. A known general purpose optimization routine that does not require derivative information is suitably used. Examples of general purpose optimization routines that can be used include the Simplex method, the Complex method and the Simulated Annealing method. In block 2306 optimum values of set of parameters are output. The inventor has used the DBCPOL FORTRAN implementation of the complex method published by Visual Numerics of San Ramon, Calif. In block 2308 initial conditions are calculated from the optimum values. If the optimization parameters are φ₀, φ_{Ω}, X_{RO} φ_{RAY} then r(φ₀), Yr(φ₀) and ∂r(φ)/∂φ (at φ₀) need to be calculated at this point. If the optimization parameters include r(φ₀) and Yr(φ₀) then only ∂r(φ)/∂φ (at φ₀) needs to be calculated at this point unless it was stored during optimization. Connector 2310 branches to block 2104 in FIG. 21 or 22.

In using a general purpose optimization routine one needs to provide a function to be optimized. The selection of values of parameters at which to evaluate the function to be optimized is handled by the general purpose optimization routine.

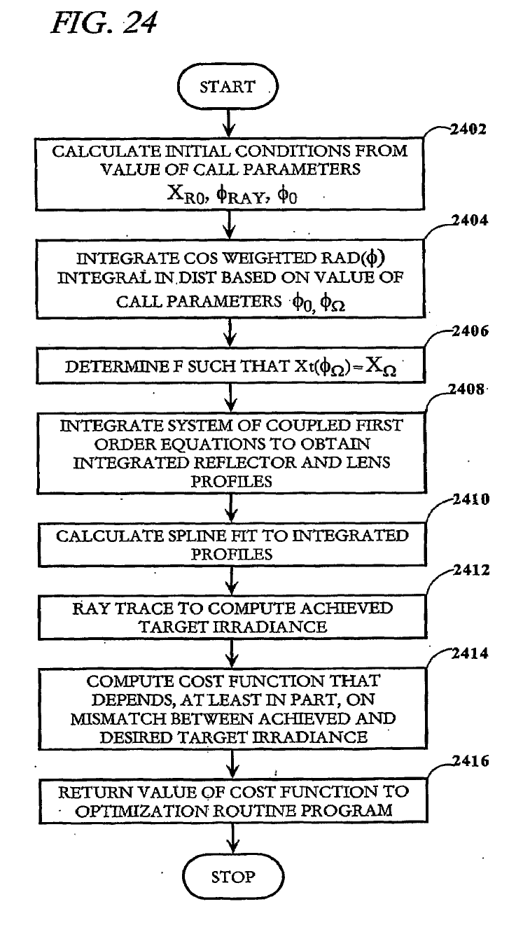

FIG. 24 is a flowchart of a subprogram 2400 that is called by an optimization routine that is called in the flowchart shown in FIG. 24. The subprogram 2400 is the function to be optimized. In block 2402 the initial conditions are calculated from the value of call parameters φ₀, X_{RO} φ_{RAY}. Note that φ_{Ω}, is not used in calculating the initial conditions. In block 2404 the integral of cos(φ) weighted light intensity Rad(φ) that appears in the denominator of DIST is calculated. Note that the integral involving Xt*Irr(Xt) from Xmin to Xmax which is independent of the parameters being optimized will have been precomputed and stored. (Note that one could allow for optimization of Xmax or a non zero Xmin within a small range in order optimize light spill at the illuminated area boundaries). In block 2406 F is determined such that Xt(φ_{Ω}, r(φ_{Ω}), ∂r(φ)/∂φ (at φ_{Ω}), Yr(φ_{Ω}))=X_{Ω}. (In block 2406 the short hand notation Xt(φ_{Ω}) is used.) In block 2408 the system of coupled differential equations defining the profiles of the luminaire optics is integrated to obtain integrated reflector and lens profiles. In block 2410 splines are fit to the integrated profiles. In block 2410 ray tracing, using the spline fits of the integrated profiles and a model of the source, e.g., a set of rays from a Prosource™ model, is performed to determine an achieved irradiance profile, and optionally the collection efficiency. In block 2410 a cost function that depends on the mismatch between the achieved irradiance profile and the desired irradiance profile Irr(x) is evaluated. The cost function can, for example, comprise a sum of squares of the differences between Irr(x) and the achieved irradiance. The cost function, optionally, also depends on the collection efficiency and/or on the angle of rays with respect to the optical axis.

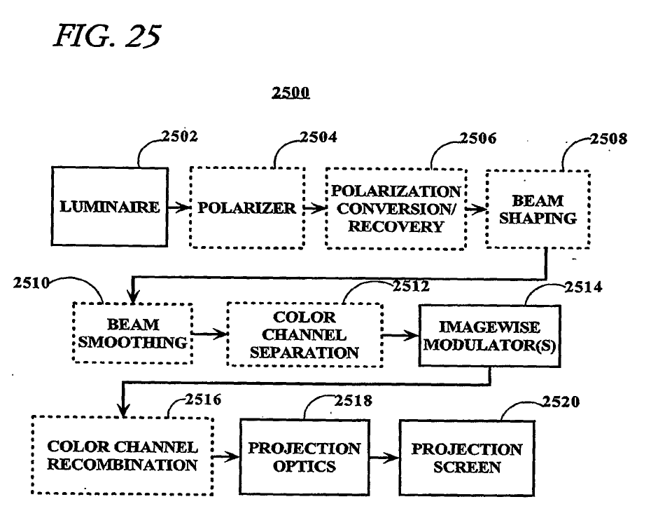

FIG. 25 is a block diagram of a projector system 2500 in which the luminaries having the luminaire optics described above can be utilized. The projector system is an example of a system that can utilize the luminaire optics described above. The projector system comprises a luminaire 2502 that includes a light source and luminaire optics described by 1, 2, 3 and 4 or by equations 1, 7, 8 and 9. The luminaire is optically coupled (e.g., by simple free space propagation, one or more relay lenses, or a light guide) to an optional polarizer 2504. Polarized light is required for certain types of image modulators (e.g. liquid crystal based image modulators) but not others (e.g., DLP™ micromirror array based modulators). The polarizer 2504 is coupled to and may be tightly integrated with an optional polarization conversion/recovery device 2506, which is intended to avoid wasting light rejected by the polarizer 2504. The polarization conversion/recovery device 2506 is coupled to an optional beam shaping device 2508. The beam shaping device 2508 includes, for example anamorphic beam expander or contractor and/or a light guide or bundle of light guides that has a cross-section size and/or shape that changes along the length of the light guide. The beam shaping device 2508 is coupled to an optional beam smoothing device 2510. The beam smoothing device 2510 includes for example a holographic diffuser. Alternatively, a kinoform or Light Shaping Diffuser serves as both the beam shaping device 2508 and the beam smoothing device 2510. Light Shaping Diffusers are manufactured by Physical Optics Corporation of Torrance, Calif. The beam smoothing device 2510 is coupled to an optional color separation apparatus 2512. The color separation apparatus includes 2512, for example, a static arrangement of dichroic mirrors that divide the light beam into a plurality (e.g., red, blue and green) separate light beams, or a dynamic filter arrangement, e.g., a rotating color wheel that filters the beam with different filters, or a rotating prism. The color separation apparatus 2512 is coupled to one or more imagewise light modulators 2514, such as transmissive or reflective liquid crystal modulators, or micromirror array modulators. (Typically, a single light modulator 2514 is used with a rotating filter wheel, and three image modulators 2514 are used with a static arrangement of dichroic mirrors.) In the case the case that multiple imagewise light modulators 2514 are used, the imagewise modulated light beams they produce are combined by an optional color channel recombination device 2516, e.g. a color combiner prism. (If a color wheel is used with a single image modulator, the color channel recombination device 2516 is not needed.) The color channel recombination device 2516 is coupled to a projection optics subsystem 2518. The projection optics subsystem suitably comprises a projection lens, reflective projection optics or a subsystem that combines lenses and reflective elements. The projection optics subsystem 2518 is coupled to a projection screen 2520 which can be a rear projection screen or a front projection screen. It is expected that the performance of many of the components of the system 2500 will be improved because the luminaire 2502 provides collimated light. Note that the specified light intensity distribution Irr(Xt) can be set to compensate for any radial coordinate dependent losses of components of the system 2500. If the overall radial coordinate dependent losses are given by Loss(Xt) and uniform luminance on the projection screen is the goal, then Irr(Xt) can be set equal to 1/Loss(Xt). Note that losses may occur at radial coordinates that are not equal to Xt but are mapped from Xt by optical coupling (e.g., via lenses) within the projector system. It will be apparent to persons having ordinary skill in the art that the order of the blocks shown in FIG. 25 can differ from what is shown in FIG. 25.

The high degree of collimation, which is associated with a small local divergence of light on the imagewise light modulator 2514 reduces geometric aberrations which tend to degrade the modulation transfer function (MTF) of the projection lens 2518. The reduction is due to the fact that such aberrations arise, in the first instance, from the light rays leaving object points at different angles. If the range of angles is limited these geometric aberrations will be limited. Diffraction limits on the MTF and image distortion are separate matters.

According to alternative embodiments DIST has the following form which takes into account, an elevation angle dependence of the spectral energy distribution of the lamp, spectral dependent light loss between the light source and the illuminated object and the spectral sensitivity of an illuminated object.

$$DIST = \pm \frac{\begin{matrix}2 πcos ( φ ) \cdot {\int }_{{λ}_{0}}^{{λ}_{Ω}} rad ( φ , λ ) \cdot \\ {r}_{R} ( {θ}_{i\_R} , λ ) \cdot ( {\prod }_{n = 1}^{N} {t}_{n} ( {θ}_{i\_n} , λ ) ) \cdot \\ {t}_{L} ( {θ}_{i\_L} , λ , Yr ( φ ) ) \cdot ( SL ( λ ) ) \cdot ( Sλ ) d λ\end{matrix}}{2 π Xt \cdot Irr ( Xt )} \cdot \frac{{\int }_{{X}_{MIN}}^{{X}_{MAX}} Xt \cdot Irr ( Xt ) d x}{{\int }_{{φ}_{0}}^{{φ}_{Ω}} cos ( φ ) \cdot {\int }_{{λ}_{0}}^{{λ}_{Ω}} rad ( φ , λ ) \cdot ( SL ( λ ) ) \cdot S ( λ ) d λ d φ} \qquad EQU . 13$$

where, Rad(φ, λ) is an elevation angle dependent spectral radiance of the light source;

r_{R}(θᵢ_{_{—}}_{R}, λ) is the spectral reflectance of the reflector which is also dependent on the angle of incidence θᵢ_{_{—}}_{R} on the reflector;

tₙ(θᵢ_{_{—}}ₙ, λ) is the spectral dependent transmission of an n^{th} transparent object (e.g., prisms, windows) between the reflector and the lens, which is also dependent on the angle of incidence θᵢ_{_{—}}ₙ on the nth transparent object;

T_{L}(θᵢ_{_{—}}_{L}, λ, Yr(φ)) is the angle of incidence θᵢ_{_{—}}_{L}, wavelength and lens thickness dependent transmission of the lens (note that the lens thickness is dependent on Yr(φ));

SL(λ) is a wavelength dependent factor that accounts for light loss (e.g., undesired reflectance, transmittance or absorption) at the illuminated object;

S(λ) is the spectral sensitivity of the illuminated object; and

λ₀ and λ_{Ω} are lower and upper spectrum limits.

In DIST given by equation 13 Rad(φ) is replaced with an integral between limits λ₀ and λ_{Ω} of an integrand that is the product of the angular dependent spectral radiance, angle of incidence and wavelength dependent spectral reflectance of the reflector, angle of incidence and wavelength dependent transmission of one or more glass objects (e.g., prisms or windows between the reflector, angle of incidence, wavelength and local thickness dependent transmission of the lens, wavelength dependent surface light loss at the illuminated object, and the spectral sensitivity of the illuminated object.

The limits of integration λ₀ and λ_{Ω} are suitably chosen to cover one or more ranges over which the integrand has non-negligible values. For example if the spectral radiance, reflectivity of the reflector, transmission of the lens or sensitivity drop to negligible values beyond a particular wavelength, the upper limit λ_{Ω} can be set equal to the particular wavelength.

Note that in the case of visible light applications, the wavelength dependence of the spectral radiance may depend on the elevation angle if the lamp exhibits what is termed ‘color separation’. Analogously, for ultraviolet or infrared applications the spectral radiance may also depend on elevation angle. On the other hand, for certain types of lamps (e.g. xenon or high pressure mercury fill lamps, for example) that do not exhibit significant color separation, the elevation angle dependence of the spectral radiance may be negligible. Spectral radiance data can be obtained by measuring the light output of a light source with a spectrometer at each of a set of elevation angles. The data collected at the set of elevation angles can then be interpolated to obtain estimates at angles other than the measurement angles. Near field radiance can also be measured at different wavelengths by using optical bandpass filters (e.g., red, blue and green filters).

In the case that the reflector includes a multilayer thin film reflecting surface, there may be significant angular dependence of the wavelength dependence of the spectral reflectance. On the other hand, in the case that the reflector includes a metal (e.g., silver, aluminum or gold for example) reflecting surface, the angular dependence of the spectral dependence of the spectral reflectance may be negligible, and in such cases may be ignored.

For luminaire optics given by equations 1, 7, 8 and 9, that are to be used with a transparent object (e.g., window, prism) between the reflector and the lens, unless an Anti-Reflection (AR) coating that works at high incident angles is going to be used, it is better to set the initial conditions and lens distance so as to avoid light rays incident on the transparent object(s) at angles larger than Brewster's angle, so as to avoid large reflection losses. For most common optical materials, the variation of reflectance loss with wavelength within the visible spectrum is negligible. Accordingly, the factor(s) tₙ(θᵢ_{_{—}}ₙ, λ) in DIST can be replaced with tₙ(θᵢ_{_{—}}ₙ) for many visible light applications. It is noted that the factors tₙ(θᵢ_{_{—}}ₙ, λ) in DIST given by equation 13 are applicable to luminaire optics defined by equations 1, 7, 8, and 9 which include one or more transparent objects between the reflector and lens.

t_{L}(θᵢ_{_{—}}_{L}, λ, Yr(φ)) accounts for Fresnel losses at the first surface of the lens which depend on the angle of incidence θᵢ_{_{—}}_{L} and wavelength λ, Fresnel losses at the bottom surface of the lens which depend on wavelength λ and bulk absorption losses incurred when light passes through the lens which depend on the wavelength λ and the local thickness of the lens traversed and hence on Yr(φ). For visible light applications using common optical glasses and plastics bulk absorption losses are negligible, and the wavelength dependence of reflection losses is also negligible. However for systems using lens material near the edges of their transmission bands (e.g., in the ultraviolet or infrared) the full form of T_{I}(θᵢ_{_{—}}_{L}, λ, Yr(φ)) taking into account bulk absorption losses may need to be used in DIST.

The spectral sensitivity S(λ) can be the photochemical sensitivity of a reaction that is to be driven by light from the luminaire. For projection applications in which the object that is illuminated by light from the luminaire is an imagewise light modulator that is imaged by a projection lens onto a projection screen which is then viewed, the spectral sensitivity can be the photopic response of the human eye, or in a system that uses multiple luminaires for multiple color channels, the spectral sensitivity can comprise a tristimulus response curve, for example.

In applications where a reflective image modulator is illuminated by the luminaire optics SL(λ) is equal to the spectral reflectance of the modulator R(λ). In this case light loss is due to transmission and/or absorption. In applications where a transmissive image modulator is illuminated by the luminaire optics SL(λ) is equal to spectral transmittance of the image modulator T(λ). In this case light loss is due to reflection and/or absorption. For applications where the desired effect of illumination depends on light being absorbed (e.g., ultraviolet photochemical curing) SL(λ) is equal to the spectral dependent absorption A(λ). In this case light loss is due to reflection or transmission. Because light that reaches the illuminated object is substantially collimated, the angular dependence of the light loss at the object need not be considered.

In practice what is known about the spectral sensitivity of certain types of objects to be illuminated may be the convolution of S(λ) and SL(λ) in which case the known convolution of these two factors is used in DIST in lieu of the two convolved factors.

The angular dependence of one or more of the spectral radiance Rad(φ, λ), the spectral reflectance of the reflector r_{R}(θᵢ_{_{—}}_{R}, λ), the spectral transmission of the transparent objects tₙ(θᵢ_{_{—}}ₙ, λ), and the spectral transmission of the lens t_{L}(θᵢ_{_{—}}_{L}, λ, Yr(φ)) will for many cases be negligible, an in such cases can be ignored leading to simplifications in DIST given by equation 13. In certain embodiments it might be appropriate to leave in an angular dependence in one or more of the factors in DIST given by equation 13, but simplify to eliminate the spectral dependence. An example of the latter case is in the case that the illuminated object (e.g., photochemical material) has a sharp spectral response at a particular wavelength (e.g., in the ultraviolet) and the reflectively of the reflector at the particular wavelength is a strong function of incidence angle. The spectral dependence of the reflectance of reflector would not need to be used, but the angle of incidence dependence of the reflectance would.

If in a particular application it is not necessary to consider the spectral dependence of the reflector reflectance r_{R}(θᵢ_{_{—}}_{R}, λ), transparent object transmission tₙ(θᵢ_{_{—}}ₙ, λ), lens transmission t_{L}(θᵢ_{_{—}}_{L}, λ, Yr(φ)), light loss at the illuminated object indicated by SL(λ), and the spectral sensitivity of the illuminated object S(λ), then DIST given by equation 13 reduces to the form of DIST given by equation 8. Furthermore, if the angle dependent transmittance of the transparent objects tₙ(θᵢ_{_{—}}ₙ) is eliminated, the form of DIST given by equation 3 is obtained.

Note that in the case that Rad(φ) is based on measurements with a filter that matches S(λ), then Rad(φ) is equivalent to Rad(φ, λ) weighted by S(λ) and integrated from λ₀ to λ_{Ω}. In other words Rad(φ) is equivalent to a convolution Rad(φ, λ) and S(λ) integrated from λ₀ to λ_{Ω}. In this regard note that the cos(φ) weighted Rad(φ) shown in FIG. 2 is based on measurements with a photopic filter S(λ) so that the cos(φ) weighted Rad(φ) is in photopic units. (Alternatively, radiometric units could be used.) Even if S(λ) and/or SL(λ) exhibit significant variation over the spectral range of interest, but the shapes (as opposed to integrated magnitudes) in the spectral domain of Rad(φ, λ), r_{R}(θᵢ_{_{—}}_{R}, λ), tₙ(θᵢ_{_{—}}ₙ, λ), T_{L}(θᵢ_{_{—}}_{L}, λ, Yr(φ)), do not vary significantly with angle then DIST given by equation 8 can be used without recourse to DIST given by equation 13.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

I claim:

1. A luminaire comprising:
a light source that emits light over a substantial range of elevation angle;
a lens having a profiled lens surface having an axial coordinate that varies as a function of a radial coordinate;
a reflector having a profiled reflector surface that is shaped to distribute light on said profiled lens surface, substantially according to a predetermined radial intensity distribution Irr(x); and
wherein said profiled lens surface is shaped to collimate light received from said reflector.

2. The luminaire according to claim 1 wherein said light source emits nonuniformly within said substantial range of elevation angle.

3. The luminaire according to claim 2 wherein said reflector subtends at least a substantial subrange of said substantial range of elevation angle, and said reflector collects at least a substantial portion of light emitted by said light source.

4. The luminaire according to claim 1 wherein said substantial range of elevation angle is at least 0.5 radians.

5. The luminaire according to claim 4 wherein said reflector collects at least 60% of light emitted by said light source.

6. A set of luminaire optics comprising:
a reflector and a lens, wherein said lens comprises a first surface and wherein generatrices of said reflector and said first surface of said lens are substantially equal to solutions of a set of coupled differential equations:
$$\begin{matrix}\begin{matrix}\begin{matrix}\begin{matrix}\frac{\partial }{\partial φ} Yr ( φ ) = \frac{cos ( - φ + 2 arctan ( \frac{\frac{\partial }{\partial φ} r ( φ )}{r ( φ )} ) ) FDIST}{- sin ( - φ + 2 arctan ( \frac{\frac{\partial }{\partial φ} r ( φ )}{r ( φ )} ) ) - Nlens} \\ \frac{{\partial }^{2}}{\partial {φ}^{2}} r ( φ ) = - ( \begin{matrix}\begin{matrix}\begin{matrix}\begin{matrix}\begin{matrix}- ( \frac{cos ( - φ + 2 arctan ( \frac{\frac{\partial }{\partial φ} r ( φ )}{r ( φ )} ) ) FDIST}{- sin ( - φ + 2 arctan ( \frac{\frac{\partial }{\partial φ} r ( φ )}{r ( φ )} ) ) - Nlens} - \\ ( \frac{\partial }{\partial φ} r ( φ ) ) sin ( φ ) - r ( φ ) cos ( φ ) -\end{matrix} \\ ( 1 + {tan ( - φ + 2 arctan ( \frac{\frac{\partial }{\partial φ} r ( φ )}{r ( φ )} ) )}^{2} )\end{matrix} \\ ( - 1 - 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} ) r ( φ ) cos ( φ ) -\end{matrix} \\ tan ( - φ + 2 arctan ( \frac{\frac{\partial }{\partial φ} r ( φ )}{r ( φ )} ) ) ( \frac{\partial }{\partial φ} r ( φ ) ) cos ( φ ) +\end{matrix} \\ tan ( - φ + 2 arctan ( \frac{\frac{\partial }{\partial φ} r ( φ )}{r ( φ )} ) ) r ( φ ) sin ( φ )\end{matrix} ) /\end{matrix} \\ tan ( - φ + 2 arctan ( \frac{\frac{\partial }{\partial φ} r ( φ )}{r ( φ )} ) ) +\end{matrix} \\ ( \begin{matrix}( \begin{matrix}Yr ( φ ) - r ( φ ) sin ( φ ) - tan \\ ( - φ + 2 arctan ( \frac{\frac{\partial }{\partial φ} r ( φ )}{r ( φ )} ) )\end{matrix} r ( φ ) cos ( φ ) ) \\ ( 1 + {tan ( - φ + 2 arctan ( \frac{\frac{\partial }{\partial φ} r ( φ )}{r ( φ )} ) )}^{2} ) \\ ( - 1 - 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} )\end{matrix} ) /\end{matrix} \\ {tan ( - φ + 2 arctan ( \frac{\frac{\partial }{\partial φ} r ( φ )}{r ( φ )} ) )}^{2} + FDIST ) / \\ ( \begin{matrix}2 \frac{( 1 + {tan ( - φ + 2 arctan ( \frac{\frac{\partial }{\partial φ} r ( φ )}{r ( φ )} ) )}^{2} ) cos ( φ )}{( 1 + \frac{{( \frac{\partial }{\partial φ} r ( φ ) )}^{2}}{{r ( φ )}^{2}} ) tan ( - φ + 2 arctan ( \frac{\frac{\partial }{\partial φ} r ( φ )}{r ( φ )} ) )} + 2 \\ ( \begin{matrix}( \begin{matrix}Yr ( φ ) - r ( φ ) sin ( φ ) - tan \\ ( - φ + 2 arctan ( \frac{\frac{\partial }{\partial φ} r ( φ )}{r ( φ )} ) )\end{matrix} r ( φ ) cos ( φ ) ) \\ ( 1 + tan {( - φ + 2 arctan ( \frac{\frac{\partial }{\partial φ} r ( φ )}{r ( φ )} ) )}^{2} )\end{matrix} ) / \\ ( {tan ( - φ + 2 arctan ( \frac{\frac{\partial }{\partial φ} r ( φ )}{r ( φ )} ) )}^{2} r ( φ ) ( 1 + \frac{{( \frac{\partial }{\partial φ} r ( φ ) )}^{2}}{{r ( φ )}^{2}} ) )\end{matrix} )\end{matrix}$$
wherein,
φ is a domain variable of a domain in which the set of coupled differential equations is defined and is also an elevation angle coordinate of a generatrix of the reflector and wherein φ is measured in a counterclockwise direction from a positive X-axis of an X-Y coordinate system, said X-Y coordinate system further comprising a Y-axis which is an optical axis of said set of luminaire optics;
r(φ) is a polar radial coordinate of the generatrix of the reflector in the X-Y coordinate system and is equal to
\sqrt{x²+y²};
Yr(φ) is equal to a Y coordinate of a generatrix of said first surface of said lens;
Nlens is an index of refraction of the lens;
DIST comprises a quotient comprising a numerator comprising Rad(φ) and a denominator comprising Irr(Xt), wherein:
Xt is an X coordinate on an illuminated plane and an X coordinate which is equivalent to a cylindrical radial coordinate, and which in combination with Yr(φ) parametrically defines the generatrix of said first surface of said lens using φ as a parameter, and wherein Xt is given by:
$$Xt := \frac{\begin{matrix}Yr ( φ ) - r ( φ ) sin ( φ ) - \\ tan ( - φ + 2 arctan ( \frac{\frac{\partial }{\partial φ} r ( φ )}{r ( φ )} ) ) r ( φ ) cos ( φ )\end{matrix}}{tan ( - φ + 2 arctan ( \frac{\frac{\partial }{\partial φ} r ( φ )}{r ( φ )} ) )}$$
Irr(Xt) is a predetermined light intensity at a given cylindrical radial coordinate;
Rad(φ) is an intensity of light emitted by a light source, for which the set of luminaire optics is designed, at elevation angle φ; and
F is a constant.

7. The set of luminaire optics according to claim 6 wherein
$$DIST = \pm \frac{\begin{matrix}2 π Rad ( φ ) \cdot cos ( φ ) \cdot \\ {r}_{R} ( {θ}_{i\_R} ) \cdot {t}_{L} ( {θ}_{i\_L} ) Rad ( φ )\end{matrix}}{2 π Xt ( φ ) \cdot Irr ( Xt )} \frac{{\int }_{{X}_{MIN}}^{{X}_{MAX}} Xt \cdot Irr ( Xt ) d x}{{\int }_{{φ}_{0}}^{{φ}_{Ω}} cos ( φ ) \cdot Rad ( φ ) d φ}$$
where,
θᵢ_{_{—}}_{R} is an angle of incidence on the reflector and is given by:
$${θ}_{i\_R} = arctan \{ \frac{1}{r ( φ )} \frac{\partial r ( φ )}{\partial φ} \}$$
r_{R}(θᵢ_{_{—}}_{R}) is the reflectance of the reflector for light incident at angle of incidence θᵢ_{_{—}}_{R};
θᵢ_{_{—}}_{L} is an angle of incidence on the lens given by:
$${θ}_{i\_L} := - \frac{1}{2} π + φ - 2 arctan ( \frac{\frac{\partial }{\partial φ} r ( φ )}{r ( φ )} ) - arctan ( - \frac{cos ( φ - 2 arctan ( \frac{\frac{\partial }{\partial φ} r ( φ )}{r ( φ )} ) )}{sin ( φ - 2 arctan ( \frac{\frac{\partial }{\partial φ} r ( φ )}{r ( φ )} ) ) - Nlens} )$$
t_{L}(θᵢ_{_{—}}_{L}) is the angle of incidence dependent transmittance of the first surface of the lens;
X_{MIN} is an inner radius of an area of the illuminated plane, wherein X_{MIN} is equal to zero if a circular area of the illuminated plane is illuminated;
X_{MAX} is an outer radius of the area of the illuminated plane;
φ₀ is a lower limit of an elevation angle range subtended by the reflector;
φ_{Ω} is an upper limit of an elevation angle range subtended by the reflector; and
F is a normalization factor that compensates for reflection losses given by r_{R}(θᵢ_{_{—}}_{R}) and transmission losses given by t_{L}(θᵢ_{_{—}}_{L}).

8. The set of luminaire optics according to claim 6 wherein:
generatrices of the reflector and lens are equal to the solutions of system of differential equations.

9. The set of luminaire optics according to claim 6 wherein:
Irr(Xt) is equal to a constant for Xt from X_{MIN} to X_{MAX}; and
Rad(φ) varies as a function of φ.

10. The set of luminaire optics according to claim 6 wherein:
$$DIST = \pm \frac{\begin{matrix}2 πcos ( φ ) \cdot {\int }_{{λ}_{0}}^{{λ}_{Ω}} \\ Rad ( φ , λ ) \cdot {r}_{R} ( {θ}_{i\_R} , λ ) \cdot \\ {t}_{L} ( {θ}_{i\_L} , λ ) \cdot ( SL ( λ ) ) \cdot S ( λ ) d λ\end{matrix}}{2 π Xt ( φ ) \cdot Irr ( Xt )} \cdot \frac{{\int }_{{X}_{MIN}}^{{X}_{MAX}} Xt \cdot Irr ( Xt ) d x}{\begin{matrix}{\int }_{{φ}_{0}}^{{φ}_{Ω}} cos ( φ ) \cdot {\int }_{{λ}_{0}}^{{λ}_{Ω}} Rad ( φ , λ ) \cdot \\ ( SL ( λ ) ) \cdot S ( λ ) d λ d φ\end{matrix}}$$
where, Rad(φ, λ) is the intensity of light emitted by the light source at elevation angle φ and a wavelength λ;
r_{R}(θᵢ_{_{—}}_{R}, λ) is a reflectance of the reflector which is dependent on an angle of incidence θᵢ_{_{—}}_{R} on the reflector and the wavelength λ, where θᵢ_{_{—}}_{R} is given by:
$${θ}_{i\_R} = arctan \{ \frac{1}{r ( φ )} \frac{\partial r ( φ )}{\partial φ} \}$$
t_{L}(θᵢ_{_{—}}_{L}, λ) is an angle of incidence θᵢ_{_{—}}_{L} and wavelength λ dependent transmission of the lens, where θᵢ_{_{—}}_{L} is given by:
$${θ}_{i\_L} := - \frac{1}{2} π + φ - 2 arctan ( \frac{\frac{\partial }{\partial φ} r ( φ )}{r ( φ )} ) - arctan ( - \frac{cos ( φ - 2 arctan ( \frac{\frac{\partial }{\partial φ} r ( φ )}{r ( φ )} ) )}{sin ( φ - 2 arctan ( \frac{\frac{\partial }{\partial φ} r ( φ )}{r ( φ )} ) ) - Nlens} )$$
SL(λ) is a factor accounting for loss of light at an illuminated object that is dependent on the wavelength λ;
X_{MIN} is an inner radius of an area of the illuminated plane, wherein X_{MIN} is equal to zero if a circular area of the illuminated plane is illuminated;
X_{MAX} is an outer radius of the area of the illuminated plane;
φ₀ is a lower limit of an elevation angle range subtended by the reflector;
φ_{Ω} is an upper limit of an elevation angle range subtended by the reflector;
S(λ) is a spectral sensitivity of the illuminated object; and
λ₀ is a lower spectral limit;
λ_{Ω} is an upper spectral limit; and
wherein a convolution of Rad(φ, λ) and S(λ) integrated from λ₀ to λ_{Ω} in DIST is equal to Rad(φ).

11. The set of luminaire optics according to claim 6 wherein an initial value of a derivative of the polar radial coordinate of the reflector is given by:
$${\frac{\partial r}{\partial φ } \vert}_{φ = {φ}_{0}} = r ( {φ}_{0} ) * tan \{ \frac{{φ}_{0}}{2} + \frac{arc tan \{ \frac{r ( {φ}_{0} ) * cos ( {φ}_{0} ) - {x}_{0}}{r ( {φ}_{0} ) * sin ( {φ}_{0} ) - Yr ( {φ}_{0} )} \}}{2} - \frac{π}{4} \}$$
wherein, φ₀ is an initial elevation angle of the reflector;
r(φ₀) is an initial polar radial coordinate of the reflector;
Yr(φ₀) is an initial Y coordinate of the first surface of the lens;
X₀ is an initial value of Xt and is equal to an X coordinate to which a ray emanating from an origin of the X-Y coordinate system at angle φ₀ is directed by the reflector and lens.

12. A luminaire comprising:
a light source that emits light nonuniformly as a function of elevation angle according wherein light intensity emitted by said light source as a function of elevation angle varies according to Rad(φ);
the set of luminaire optics according to claim 6.

13. A projection system comprising:
a imagewise light modulator;
a projection optics subsystem; and
the luminaire according to claim 12, wherein the luminaire is optically coupled to the imagewise light modulator, and the imagewise light modulator is optically coupled to the projection optics subsystem.

14. The luminaire according to claim 12 wherein the light emitted by the light source is substantially confined to an elevation angle range that is less than 180 degrees, whereby the light source does not emit significant light along the optical axis.

15. The luminaire according to claim 14 wherein the light source comprises a compact arc lamp having a longitudinal axis aligned on the optical axis.

16. A luminaire comprising:
a discharge envelope enclosing a discharge fill, wherein said reflector and said first surface of said lens according to claim 6 are in contact with said discharge fill.

17. A set of luminaire optics comprising:
a reflector, a lens, and one or more transparent object disposed along an optical axis between the reflector and the lens, wherein said lens comprises a first surface and wherein generatrices of said reflector and said first surface of said lens are substantially equal to solutions of a set of coupled differential equations:
$$\begin{matrix}\frac{\partial }{\partial φ} Yr ( φ ) = \frac{cos ( - φ + 2 arc tan ( \frac{\frac{\partial }{\partial φ} r ( φ )}{r ( φ )} ) ) FDIST}{- sin ( - φ + 2 arc tan ( \frac{\frac{\partial }{\partial φ} r ( φ )}{r ( φ )} ) ) - Nlens} \\ \frac{{\partial }^{2}}{\partial {φ}^{2}} r ( φ ) = - ( \begin{matrix}\begin{matrix}\begin{matrix}\begin{matrix}\begin{matrix}( \frac{cos ( φ - 2 arc tan ( \frac{\frac{\partial }{\partial φ} r ( φ )}{r ( φ )} ) ) FDIST}{sin ( φ - 2 arc tan ( \frac{\frac{\partial }{\partial φ} r ( φ )}{r ( φ )} ) ) - Nlens} - \\ ( \frac{\partial }{\partial φ} r ( φ ) ) sin ( φ ) - r ( φ ) cos ( φ ) +\end{matrix} \\ ( 1 + {tan ( φ - 2 arc tan ( \frac{\frac{\partial }{\partial φ} r ( φ )}{r ( φ )} ) )}^{2} )\end{matrix} \\ ( 1 + 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} ) r ( φ ) cos ( φ ) +\end{matrix} \\ tan ( φ - 2 arc tan ( \frac{\frac{\partial }{\partial φ} r ( φ )}{r ( φ )} ) ) ( \frac{\partial }{\partial φ} r ( φ ) ) cos ( φ ) -\end{matrix} \\ tan ( φ - 2 arc tan ( \frac{\frac{\partial }{\partial φ} r ( φ )}{r ( φ )} ) ) r ( φ ) sin ( φ )\end{matrix} ) / \\ tan ( φ - 2 arc tan ( \frac{\frac{\partial }{\partial φ} r ( φ )}{r ( φ )} ) ) + \\ ( - 1 - {cot ( φ - 2 arc tan ( \frac{\frac{\partial }{\partial φ} r ( φ )}{r ( φ )} ) )}^{2} ) \\ ( 1 + 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} ) ( {\sum }_{n = 1}^{N} {th}_{n} ) - \\ ( \begin{matrix}( \begin{matrix}Yr ( φ ) - r ( φ ) sin ( φ ) + \\ tan ( φ - 2 arc tan ( \frac{\frac{\partial }{\partial φ} r ( φ )}{r ( φ )} ) ) r ( φ ) cos ( φ )\end{matrix} ) \\ ( 1 + {tan ( φ - 2 arc tan ( \frac{\frac{\partial }{\partial φ} r ( φ )}{r ( φ )} ) )}^{2} ) \\ ( 1 + 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} )\end{matrix} ) / \\ tan {( φ - 2 arc tan ( \frac{\frac{\partial }{\partial φ} r ( φ )}{r ( φ )} ) )}^{2} + FDIST + \\ ( {\sum }_{n = 1}^{N} ( \frac{\begin{matrix}\begin{matrix}{th}_{n} no sin \\ ( φ - 2 arc tan ( \frac{\frac{\partial }{\partial φ} r ( φ )}{r ( φ )} ) )\end{matrix} \\ ( 1 + 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} )\end{matrix}}{{np}_{n} \sqrt{1 - \frac{{no}^{2} {cos ( φ - 2 arc tan ( \frac{\frac{\partial }{\partial φ} r ( φ )}{r ( φ )} ) )}^{2}}{{np}_{n}^{2}}}} + \\ \frac{\begin{matrix}{th}_{n} {no}^{3} {cos ( φ - 2 arc tan ( \frac{\frac{\partial }{\partial φ} r ( φ )}{r ( φ )} ) )}^{2} \\ sin ( φ - 2 arc tan ( \frac{\frac{\partial }{\partial φ} r ( φ )}{r ( φ )} ) ) \\ ( 1 + 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} )\end{matrix}}{{{np}_{n}^{3} ( 1 - \frac{{no}^{2} {cos ( φ - 2 arc tan ( \frac{\frac{\partial }{\partial φ} r ( φ )}{r ( φ )} ) )}^{2}}{{np}_{n}^{2}} )}^{( \frac{3}{2} )}} ) ) ) / \\ ( - 2 \frac{( 1 + {tan ( φ - 2 arc tan ( \frac{\frac{\partial }{\partial φ} r ( φ )}{r ( φ )} ) )}^{2} ) cos ( φ )}{( 1 + \frac{{( \frac{\partial }{\partial φ} r ( φ ) )}^{2}}{{r ( φ )}^{2}} ) tan ( φ - 2 arc tan ( \frac{\frac{\partial }{\partial φ} r ( φ )}{r ( φ )} ) )} - 2 \\ \frac{( - 1 - {cot ( φ - 2 arc tan ( \frac{\frac{\partial }{\partial φ} r ( φ )}{r ( φ )} ) )}^{2} ) ( {\sum }_{n = 1}^{N} {th}_{n} )}{{r ( φ )}^{2} ( 1 + \frac{{( \frac{\partial }{\partial φ} r ( φ ) )}^{2}}{{r ( φ )}^{2}} )} + 2 \\ \frac{( \begin{matrix}\begin{matrix}Yr ( φ ) - r ( φ ) sin ( φ ) + \\ tan ( φ - 2 arc tan ( \frac{\frac{\partial }{\partial φ} r ( φ )}{r ( φ )} ) ) r ( φ ) cos ( φ )\end{matrix} \\ ( 1 + {tan ( φ - 2 arc tan ( \frac{\frac{\partial }{\partial φ} r ( φ )}{r ( φ )} ) )}^{2} )\end{matrix} )}{{tan ( φ - 2 arc tan ( \frac{\frac{\partial }{\partial φ} r ( φ )}{r ( φ )} ) )}^{2} r ( φ ) ( 1 + \frac{{( \frac{\partial }{\partial φ} r ( φ ) )}^{2}}{{r ( φ )}^{2}} )} + \\ ( {\sum }_{n = 1}^{N} ( - 2 \frac{{th}_{n} no sin ( φ - 2 arc tan ( \frac{\frac{\partial }{\partial φ} r ( φ )}{r ( φ )} ) )}{\begin{matrix}{np}_{n} r ( φ ) ( 1 + \frac{{( \frac{\partial }{\partial φ} r ( φ ) )}^{2}}{{r ( φ )}^{2}} ) \\ \sqrt{1 - \frac{{no}^{2} {cos ( φ - 2 arc tan ( \frac{\frac{\partial }{\partial φ} r ( φ )}{r ( φ )} ) )}^{2}}{{np}_{n}^{2}}}\end{matrix}} - 2 \\ \frac{\begin{matrix}{th}_{n} {no}^{3} {cos ( φ - 2 arc tan ( \frac{\frac{\partial }{\partial φ} r ( φ )}{r ( φ )} ) )}^{2} \\ sin ( φ - 2 arc tan ( \frac{\frac{\partial }{\partial φ} r ( φ )}{r ( φ )} ) )\end{matrix}}{\begin{matrix}{{np}_{n}^{3} ( 1 - \frac{{no}^{2} {cos ( φ - 2 arc tan ( \frac{\frac{\partial }{\partial φ} r ( φ )}{r ( φ )} ) )}^{2}}{{np}_{n}^{2}} )}^{( \frac{3}{2} )} \\ r ( φ ) ( 1 + \frac{{( \frac{\partial }{\partial φ} r ( φ ) )}^{2}}{{r ( φ )}^{2}} )\end{matrix}} ) ) )\end{matrix}$$
where, capital N is a number of transparent objects positioned between the reflector and lens;
lower case n is an index that refers to each nth transparent object;
no is an index of refraction in an environment of the set of luminaire optics;
thₙ is a thickness, measured along the optical axis of the n^{th} transparent object;
npₙ is the index of refraction of the n^{th} transparent object;
φ is a domain variable of a domain in which the set of coupled differential equations are defined and is also an elevation angle coordinate of a generatrix of the reflector and wherein φ is measured in a counterclockwise direction from a positive X-axis of an X-Y coordinate system, said X-Y coordinate system further comprising a Y-axis which is an optical axis of said set of luminaire optics;
r(φ) is a polar radial coordinate of the generatrix of the reflector in the X-Y coordinate system r(φ) and is equal to \sqrt{x²+y²};
Yr(φ) is equal to a Y coordinate of a generatrix of said first surface of said lens;
Nlens is an index of refraction of the lens;
DIST comprises a quotient comprising a numerator comprising cos(φ)*Rad(φ) and a denominator comprising Xt*Irr(Xt), wherein:
Xt is an X coordinate on an illuminated plane and an X coordinate which is equivalent to a cylindrical radial coordinate, and which in combination with Yr(φ) parametrically defines the generatrix of said first surface of said lens using φ as a parameter, and wherein Xt is given by:
$$Xt := \frac{Yr ( φ ) - r ( φ ) sin ( φ ) + tan ( φ - 2 arc tan ( \frac{\frac{\partial }{\partial φ} r ( φ )}{r ( φ )} ) ) r ( φ ) cos ( φ )}{tan ( φ - 2 arc tan ( \frac{\frac{\partial }{\partial φ} r ( φ )}{r ( φ )} ) )} + ( {\sum }_{n = 1}^{N} ( - \frac{{th}_{n} no cos ( φ - 2 arc tan ( \frac{\frac{\partial }{\partial φ} r ( φ )}{r ( φ )} ) )}{{np}_{n} \sqrt{1 - \frac{{no}^{2} {cos ( φ - 2 arc tan ( \frac{\frac{\partial }{\partial φ} r ( φ )}{r ( φ )} ) )}^{2}}{{np}_{n}^{2}}}} ) ) + cot ( φ - 2 arc tan ( \frac{\frac{\partial }{\partial φ} r ( φ )}{r ( φ )} ) ) ( {\sum }_{n = 1}^{N} {th}_{n} )$$
Irr(Xt) is a predetermined light intensity at a given cylindrical radial coordinate;
Rad(φ) is an intensity of light emitted by a source, for which the set of luminaire optics are designed, at elevation angle φ; and
F is a constant.

18. The set of luminaire optics according to claim 17 wherein
$$DIST = \pm \frac{\begin{matrix}2 πcos ( φ ) \cdot ( {\prod }_{n = 1}^{N} {t}_{n} ( {θ}_{i\_n} ) ) \cdot \\ {r}_{R} ( {θ}_{i\_R} ) \cdot {t}_{L} ( {θ}_{i\_L} ) Rad ( φ )\end{matrix}}{2 π Xt ( φ ) \cdot Irr ( Xt )} \frac{{\int }_{{X}_{MIN}}^{{X}_{MAX}} Xt \cdot Irr ( Xt ) d x}{{\int }_{{φ}_{0}}^{{φ}_{Ω}} cos ( φ ) \cdot Rad ( φ ) d φ}$$
where,
θᵢ_{_{—}}_{R} is an angle of incidence on the reflector and is given by:
$$( {θ}_{i\_R} ) = arc tan \{ \frac{1}{r ( φ )} \frac{\partial r ( φ )}{\partial φ} \}$$
r_{R}(θᵢ_{_{—}}_{R}) is the reflectance of the reflector for light incident at angle of incidence θᵢ_{_{—}}_{R};
θᵢ_{_{—}}ₙ is an angle of incidence on an nth transparent object and is given by;
$${θ}_{i\_n} = arcsin ( \frac{no}{{np}_{n - 1}} sin ( {θ}_{RR} ) )$$
$$where , {θ}_{RR} = abs ( \frac{π}{2} - φ + 2 arc tan ( \frac{1}{r} \frac{\partial r}{\partial φ} ) )$$
tₙ(θᵢ_{_{—}}ₙ) is the transmittance of the n^{th} transparent object;
θᵢ_{_{—}}_{L} is an angle of incidence on the lens given by:
$${θ}_{i\_L} := - \frac{1}{2} π + φ - 2 arc tan ( \frac{\frac{\partial }{\partial φ} r ( φ )}{r ( φ )} ) - arc tan ( - \frac{cos ( φ - 2 arc tan ( \frac{\frac{\partial }{\partial φ} r ( φ )}{r ( φ )} ) )}{sin ( φ - 2 arc tan ( \frac{\frac{\partial }{\partial φ} r ( φ )}{r ( φ )} ) ) - Nlens} )$$
t_{L}(θᵢ_{_{—}}_{L}) is the angle of incidence dependent transmittance of the first surface of the lens;
X_{MIN} is an inner radius of an area of the illuminated plane, wherein X_{MIN} is equal to zero if a circular area of the illuminated plane is illuminated;
X_{MAX} is an outer radius of the area of the illuminated plane;
φ₀ is a lower limit of an elevation angle range subtended by the reflector;
φ_{Ω} is an upper limit of an elevation angle range subtended by the reflector; and
F is a normalization factor that compensates for reflection losses given by r_{R}(θᵢ_{_{—}}_{R}) and transmission losses given by t_{L}(θᵢ_{_{—}}_{L}) and tₙ(θᵢ_{_{—}}ₙ).

19. The set of luminaire optics according to claim 17 wherein:
generatrices of the reflector and lens are equal to the solutions of system of differential equations.

20. The set of luminaire optics according to claim 17 wherein:
Irr(Xt) is equal to a constant for Xt from X_{MIN} to X_{MAX}; and
Rad(φ) varies as a function of φ.

21. The set of luminaire optics according to claim 17 wherein:
$$DIST = \pm \frac{\begin{matrix}2 π cos ( φ ) \cdot {\int }_{{λ}_{0}}^{{λ}_{Ω}} Rad ( φ , λ ) \cdot {r}_{R} ( {θ}_{i\_R} , λ ) \cdot \\ ( {\prod }_{n = 1}^{N} {t}_{n} ( {θ}_{i\_n} , λ ) ) \cdot {t}_{L} ( {θ}_{i\_L} , λ ) \cdot \\ ( SL ( λ ) ) \cdot S ( λ ) d λ\end{matrix}}{2 π Xt \cdot {I}_{rr} ( Xt )} \cdot \frac{{\int }_{{X}_{MIN}}^{{X}_{MAX}} Xt \cdot Irr ( Xt ) d x}{{\int }_{{φ}_{0}}^{{φ}_{Ω}} cos ( φ ) \cdot {\int }_{{λ}_{0}}^{{λ}_{0}} Rad ( φ , λ ) \cdot ( SL ( λ ) ) \cdot S ( λ ) d λ d φ}$$
where, Rad(φ, λ) is the intensity of light emitted by the source at elevation angle φ and wavelength λ;
r_{R}(θᵢ_{_{—}}_{R}, λ) is a reflectance of the reflector which is dependent on an angle of incidence θᵢ_{_{—}}_{R} on the reflector and the wavelength λ, where θᵢ_{_{—}}_{R} is given by:
$${θ}_{i\_R} = arc tan \{ \frac{1}{r ( φ )} \frac{\partial r ( φ )}{\partial φ} \}$$
tₙ(θᵢ_{_{—}}ₙ, λ) is a transmission of an nth transparent object disposed between the reflector and the lens, which is dependent on the wavelength λ, and an angle of incidence θᵢ_{_{—}}ₙ on the nth transparent object, where θᵢ_{_{—}}ₙ is given by:
$${θ}_{i\_n} = arcsin ( \frac{no}{{np}_{n - 1}} sin ( {θ}_{RR} ) )$$
$$where , {θ}_{RR} = abs ( \frac{π}{2} - φ + 2 arc tan ( \frac{1}{r} \frac{\partial r}{\partial φ} ) )$$
t_{L}(θᵢ_{_{—}}_{L}, λ) is an angle of incidence θᵢ_{_{—}}_{L} and wavelength λ dependent transmission of the lens, where θᵢ_{_{—}}_{L} is given by:
$${θ}_{i\_L} := - \frac{1}{2} π + φ - 2 arc tan ( \frac{\frac{\partial }{\partial φ} r ( φ )}{r ( φ )} ) - arc tan ( - \frac{cos ( φ - 2 arc tan ( \frac{\frac{\partial }{\partial φ} r ( φ )}{r ( φ )} ) )}{sin ( φ - 2 arc tan ( \frac{\frac{\partial }{\partial φ} r ( φ )}{r ( φ )} ) ) - Nlens} ) .$$
SL(λ) is a factor accounting for loss of light at an illuminated object that is dependent on the wavelength λ;
X_{MIN} is an inner radius of an area of the illuminated plane, wherein X_{MIN} is equal to zero if a circular area of the illuminated plane is illuminated;
X_{MAX} is an outer radius of the area of the illuminated plane;
φ₀ is a lower limit of an elevation angle range subtended by the reflector;
φ_{Ω} is an upper limit of an elevation angle range subtended by the reflector
S(λ) is a spectral sensitivity of the illuminated object;
λ₀ is a lower spectral limit;
λ_{Ω} is an upper spectral limit; and
wherein a convolution of Rad(φ, λ) and S(λ) integrated from λ₀ to λλ_{Ω} in DIST is equal to Rad(φ).

22. A luminaire comprising:
a source that emits light nonuniformly as a function of elevation angle, wherein light intensity of the light source as a function of elevation angle varies according to Rad(φ);
the set of luminaire optics according to claim 16.

23. A projection system comprising:
a imagewise light modulator;
a projection optics subsystem; and
the luminaire according to claim 22, wherein the luminaire is optically coupled to the imagewise light modulator, and the imagewise light modulator is optically coupled to the projection optics subsystem.

24. The luminaire according to claim 22 wherein light emitted by the source is substantially confined to an elevation angle range that is less than 180 degrees, wherein the source does not emit significant light along the optical axis.

25. The luminaire according to claim 24 wherein the source comprises a compact arc lamp having a longitudinal axis aligned on the optical axis.

26. An optical system comprising:
an integrated luminaire comprising:
a discharge envelope enclosing a discharge fill, said discharge envelope including a window that is a first of said number of transparent objects according to claim 17;
wherein the reflector according to claim 17 is part of said integrated luminaire and is in contact with said discharge fill, whereby light is reflected by said reflector through said window to said first surface of said lens.

27. A method of manufacturing a set of luminaire optics comprising:
setting initial conditions for a system of coupled differential equations that describe generatrices of a reflector and a first surface of a lens that complements the reflector, wherein the lens and the reflector distribute light substantially according to a predetermined distribution and collimate light;
integrating the system of equations to obtain integrated solutions;
inputting data representing the integrated solutions into one or more computer numeric control machine tools.

28. The method according to claim 27 further comprising:
using the one or more computer numeric control machine tools to machine tooling for manufacturing the reflector and the lens.

29. The method according to claim 27 wherein the system of coupled differential equations comprises:
$$\begin{matrix}\frac{\partial }{\partial φ} Yr ( φ ) = \frac{cos ( - φ + 2 arc tan ( \frac{\frac{\partial }{\partial φ} r ( φ )}{r ( φ )} ) ) FDIST}{- sin ( - φ + 2 arc tan ( \frac{\frac{\partial }{\partial φ} r ( φ )}{r ( φ )} ) ) - Nlens} \\ \frac{{\partial }^{2}}{\partial {φ}^{2}} r ( φ ) = - ( \begin{matrix}- ( \frac{cos ( φ - 2 arc tan ( \frac{\frac{\partial }{\partial φ} r ( φ )}{r ( φ )} ) ) FDIST}{sin ( φ - 2 arc tan ( \frac{\frac{\partial }{\partial φ} r ( φ )}{r ( φ )} ) ) - Nlens} - \\ ( \frac{\partial }{\partial φ} r ( φ ) ) sin ( φ ) - r ( φ ) cos ( φ ) - \\ ( 1 + {tan ( - φ + 2 arc tan ( \frac{\frac{\partial }{\partial φ} r ( φ )}{r ( φ )} ) )}^{2} ) \\ ( - 1 - 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} ) r ( φ ) cos ( φ ) - \\ tan ( - φ + 2 arc tan ( \frac{\frac{\partial }{\partial φ} r ( φ )}{r ( φ )} ) ) ( \frac{\partial }{\partial φ} r ( φ ) ) cos ( φ ) + \\ tan ( - φ + 2 arc tan ( \frac{\frac{\partial }{\partial φ} r ( φ )}{r ( φ )} ) ) r ( φ ) sin ( φ )\end{matrix} ) / \\ tan ( - φ + 2 arc tan ( \frac{\frac{\partial }{\partial φ} r ( φ )}{r ( φ )} ) ) + \\ ( \begin{matrix}\begin{matrix}\begin{matrix}Yr ( φ ) - r ( φ ) sin ( φ ) - tan \\ ( - φ + 2 arc tan ( \frac{\frac{\partial }{\partial φ} r ( φ )}{r ( φ )} ) ) r ( φ ) cos ( φ ) )\end{matrix} \\ ( 1 + {tan ( - φ + 2 arc tan ( \frac{\frac{\partial }{\partial φ} r ( φ )}{r ( φ )} ) )}^{2} )\end{matrix} \\ ( - 1 - 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} )\end{matrix} ) / \\ {tan ( - φ + 2 arc tan ( \frac{\frac{\partial }{\partial φ} r ( φ )}{r ( φ )} ) )}^{2} + FDIST ) / \\ ( 2 \frac{( 1 + {tan ( - φ + 2 arc tan ( \frac{\frac{\partial }{\partial φ} r ( φ )}{r ( φ )} ) )}^{2} ) cos ( φ )}{( 1 + \frac{{( \frac{\partial }{\partial φ} r ( φ ) )}^{2}}{{r ( φ )}^{2}} ) tan ( - φ + 2 arc tan ( \frac{\frac{\partial }{\partial φ} r ( φ )}{r ( φ )} ) )} + 2 \\ ( \begin{matrix}\begin{matrix}( Yr ( φ ) - r ( φ ) sin ( φ ) + tan \\ ( - φ + 2 arc tan ( \frac{\frac{\partial }{\partial φ} r ( φ )}{r ( φ )} ) ) r ( φ ) cos ( φ ) )\end{matrix} \\ ( 1 + {tan ( - φ + 2 arc tan ( \frac{\frac{\partial }{\partial φ} r ( φ )}{r ( φ )} ) )}^{2} )\end{matrix} ) / \\ ( tan {( - φ + 2 arc tan ( \frac{\frac{\partial }{\partial φ} r ( φ )}{r ( φ )} ) )}^{2} r ( φ ) ( 1 + \frac{{( \frac{\partial }{\partial φ} r ( φ ) )}^{2}}{{r ( φ )}^{2}} ) ) )\end{matrix}$$
wherein,
φ is a domain variable of a domain in which the set of coupled differential equations are defined and is also an elevation angle coordinate of a generatrix of the reflector and wherein φ is measured in a counterclockwise direction from a positive X-axis of an X-Y coordinate system;
r(φ) is a polar radial coordinate of the generatrix of the reflector in the X-Y coordinate system and is equal to \sqrt{x²+y²};
Yr(φ) is equal to a Y coordinate of a generatrix of said first surface of said lens;
Nlens is an index of refraction of the lens;
DIST comprises a quotient comprising a numerator comprising Rad(φ) and a denominator comprising Irr(Xt), wherein:
Xt is an X coordinate on an illuminated plane and an X coordinate which is equivalent to a cylindrical radial coordinate, and which in combination with Yr(φ) parametrically defines the generatrix of said first surface of said lens using φ as a parameter, and wherein Xt is given by:
$$Xt := - \frac{\begin{matrix}Yr ( φ ) - r ( φ ) sin ( φ ) - \\ tan ( - φ + 2 arctan ( \frac{\frac{\partial }{\partial φ} r ( φ )}{r ( φ )} ) ) r ( φ ) cos ( φ )\end{matrix}}{tan ( - φ + 2 arctan ( \frac{\frac{\partial }{\partial φ} r ( φ )}{r ( φ )} ) )}$$
Irr(Xt) is a predetermined light intensity at a given cylindrical radial coordinate;
Rad(φ) is an intensity of light emitted by a light source, for which the set of luminaire optics are designed, at elevation angle φ; and
F is a constant.

30. The method according to claim 27 wherein the system of coupled differential equations comprises:
$$\begin{matrix}\frac{\partial }{\partial φ} Yr ( φ ) = \frac{cos ( - φ + 2 arc tan ( \frac{\frac{\partial }{\partial φ} r ( φ )}{r ( φ )} ) ) FDIST}{- sin ( - φ + 2 arc tan ( \frac{\frac{\partial }{\partial φ} r ( φ )}{r ( φ )} ) ) - Nlens} \\ \frac{{\partial }^{2}}{\partial {φ}^{2}} r ( φ ) = - ( \begin{matrix}\begin{matrix}\begin{matrix}\begin{matrix}\begin{matrix}( \frac{cos ( φ - 2 arc tan ( \frac{\frac{\partial }{\partial φ} r ( φ )}{r ( φ )} ) ) FDIST}{sin ( φ - 2 arc tan ( \frac{\frac{\partial }{\partial φ} r ( φ )}{r ( φ )} ) ) - Nlens} - \\ ( \frac{\partial }{\partial φ} r ( φ ) ) sin ( φ ) - r ( φ ) cos ( φ ) +\end{matrix} \\ ( 1 + {tan ( - φ + 2 arc tan ( \frac{\frac{\partial }{\partial φ} r ( φ )}{r ( φ )} ) )}^{2} )\end{matrix} \\ ( 1 + 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} ) r ( φ ) cos ( φ ) +\end{matrix} \\ tan ( φ - 2 arc tan ( \frac{\frac{\partial }{\partial φ} r ( φ )}{r ( φ )} ) ) ( \frac{\partial }{\partial φ} r ( φ ) ) cos ( φ ) -\end{matrix} \\ tan ( φ - 2 arc tan ( \frac{\frac{\partial }{\partial φ} r ( φ )}{r ( φ )} ) ) r ( φ ) sin ( φ )\end{matrix} ) / \\ tan ( φ - 2 arc tan ( \frac{\frac{\partial }{\partial φ} r ( φ )}{r ( φ )} ) ) + \\ ( - 1 - {cot ( φ - 2 arc tan ( \frac{\frac{\partial }{\partial φ} r ( φ )}{r ( φ )} ) )}^{2} ) \\ ( 1 + 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} ) ( {\sum }_{n = 1}^{N} {th}_{n} ) - \\ ( \begin{matrix}\begin{matrix}( \begin{matrix}Yr ( φ ) - r ( φ ) sin ( φ ) + tan \\ ( φ - 2 arc tan ( \frac{\frac{\partial }{\partial φ} r ( φ )}{r ( φ )} ) ) r ( φ ) cos ( φ )\end{matrix} ) \\ ( 1 + {tan ( φ - 2 arc tan ( \frac{\frac{\partial }{\partial φ} r ( φ )}{r ( φ )} ) )}^{2} )\end{matrix} \\ ( 1 + 2 \frac{{( \frac{\partial }{\partial φ} r ( φ ) )}^{2}}{{r ( φ )}^{2} ( 1 + \frac{{( \frac{\partial }{\partial φ} r ( φ ) )}^{2}}{{r ( φ )}^{2}} )} )\end{matrix} ) / \\ {tan ( φ - 2 arc tan ( \frac{\frac{\partial }{\partial φ} r ( φ )}{r ( φ )} ) )}^{2} + FDIST + \\ ( {\sum }_{n = 1}^{N} ( \frac{\begin{matrix}{th}_{n} no sin ( φ - 2 arc tan ( \frac{\frac{\partial }{\partial φ} r ( φ )}{r ( φ )} ) ) \\ ( 1 + 2 \frac{( {( \frac{\partial }{\partial φ} r ( φ ) )}^{2} )}{( {r ( φ )}^{2} ( 1 + \frac{( {( \frac{\partial }{\partial φ} r ( φ ) )}^{2} )}{( {r ( φ )}^{2} )} ) )} )\end{matrix}}{{np}_{n} \sqrt{1 - \frac{{no}^{2} {cos ( φ - 2 arc tan ( \frac{\frac{\partial }{\partial φ} r ( φ )}{r ( φ )} ) )}^{2}}{{np}_{n}^{2}}}} + \\ \frac{\begin{matrix}{th}_{n} {no}^{3} {cos ( φ - 2 arc tan ( \frac{\frac{\partial }{\partial φ} r ( φ )}{r ( φ )} ) )}^{2} \\ sin ( φ - 2 arc tan ( \frac{\frac{\partial }{\partial φ} r ( φ )}{r ( φ )} ) ) \\ ( 1 + 2 \frac{( {( \frac{\partial }{\partial φ} r ( φ ) )}^{2} )}{{r ( φ )}^{2} ( 1 + \frac{( {( \frac{\partial }{\partial φ} r ( φ ) )}^{2} )}{( {r ( φ )}^{2} )} )} )\end{matrix}}{{{np}_{n}^{3} ( 1 - \frac{{no}^{2} {cos ( φ - 2 arc tan ( \frac{\frac{\partial }{\partial φ} r ( φ )}{r ( φ )} ) )}^{2}}{{np}_{n}^{2}} )}^{( \frac{3}{2} )}} ) ) ) / \\ ( - 2 \frac{( 1 + {tan ( φ - 2 arc tan ( \frac{\frac{\partial }{\partial φ} r ( φ )}{r ( φ )} ) )}^{2} ) cos ( φ )}{( 1 + \frac{{( \frac{\partial }{\partial φ} r ( φ ) )}^{2}}{( {r ( φ )}^{2} )} ) tan ( φ - 2 arc tan ( \frac{\frac{\partial }{\partial φ} r ( φ )}{r ( φ )} ) )} \\ - 2 \frac{( - 1 - {cot ( φ - 2 arc tan ( \frac{\frac{\partial }{\partial φ} r ( φ )}{r ( φ )} ) )}^{2} ) ( {\sum }_{n = 1}^{N} {th}_{n} )}{r ( φ ) ( 1 + \frac{{( \frac{\partial }{\partial φ} r ( φ ) )}^{2}}{( {r ( φ )}^{2} )} )} + 2 \\ \frac{\begin{matrix}( \begin{matrix}Yr ( φ ) - r ( φ ) sin ( φ ) + tan \\ ( φ - 2 arc tan ( \frac{\frac{\partial }{\partial φ} r ( φ )}{r ( φ )} ) ) r ( φ ) cos ( φ )\end{matrix} ) \\ ( 1 + {tan ( φ - 2 arc tan ( \frac{\frac{\partial }{\partial φ} r ( φ )}{r ( φ )} ) )}^{2} )\end{matrix}}{{tan ( φ - 2 arc tan ( \frac{\frac{\partial }{\partial φ} r ( φ )}{r ( φ )} ) )}^{2} r ( φ ) ( 1 + \frac{( {( \frac{\partial }{\partial φ} r ( φ ) )}^{2} )}{( {r ( φ )}^{2} )} )} + \\ ( {\sum }_{n = 1}^{N} ( - 2 \frac{{th}_{n} no sin ( φ - 2 arc tan ( \frac{\frac{\partial }{\partial φ} r ( φ )}{r ( φ )} ) )}{\begin{matrix}{np}_{n} r ( φ ) ( 1 + \frac{{( \frac{\partial }{\partial φ} r ( φ ) )}^{2}}{( {r ( φ )}^{2} )} ) \\ \sqrt{1 - \frac{{no}^{2} {cos ( φ - 2 arc tan ( \frac{\frac{\partial }{\partial φ} r ( φ )}{r ( φ )} ) )}^{2}}{{np}_{n}^{2}}}\end{matrix}} - 2 \\ \frac{\begin{matrix}{th}_{n} {no}^{3} {cos ( φ - 2 arc tan ( \frac{\frac{\partial }{\partial φ} r ( φ )}{r ( φ )} ) )}^{2} \\ sin ( φ - 2 arc tan ( \frac{\frac{\partial }{\partial φ} r ( φ )}{r ( φ )} ) )\end{matrix}}{\begin{matrix}{{np}_{n}^{3} ( 1 - \frac{{no}^{2} {cos ( φ - 2 arc tan ( \frac{\frac{\partial }{\partial φ} r ( φ )}{r ( φ )} ) )}^{2}}{{np}_{n}^{2}} )}^{( \frac{3}{2} )} \\ r ( φ ) ( 1 + \frac{{( \frac{\partial }{\partial φ} r ( φ ) )}^{2}}{( {r ( φ )}^{2} )} )\end{matrix}} ) ) )\end{matrix}$$
where, capital N is a number of one or more transparent objects positioned between the reflector and lens;
lower case n is an index that refers to each nth transparent object;
no is an index of refraction in an environment of the luminaire optics;
thₙ is a thickness, measured along the optical axis of the n^{th} transparent object;
npₙ is the index of refraction of the n^{th} transparent object;
φ is a domain variable of a domain in which the set of coupled differential equations are defined and is also an elevation angle coordinate of a generatrix of the reflector and wherein φ is measured in a counterclockwise direction from a positive X-axis of an X-Y coordinate system;
r(φ) is a polar radial coordinate of the generatrix of the reflector in the X-Y coordinate system and is equal to \sqrt{x²+y²};
Yr(φ) is equal to a Y coordinate of a generatrix of said first surface of said lens;
Nlens is an index of refraction of the lens;
DIST comprises a quotient comprising a numerator comprising Rad(φ) and a denominator comprising Irr(Xt), wherein:
Xt is an X coordinate on an illuminated plane and an X coordinate which is equivalent to a cylindrical radial coordinate, and which in combination with Yr(φ) parametrically defines the generatrix of said first surface of said lens using φ as a parameter, and wherein Xt is given by:
$$Xt := - \frac{\begin{matrix}Yr ( φ ) - r ( φ ) sin ( φ ) + \\ tan ( - φ + 2 arctan ( \frac{\frac{\partial }{\partial φ} r ( φ )}{r ( φ )} ) ) r ( φ ) cos ( φ )\end{matrix}}{tan ( - φ + 2 arctan ( \frac{\frac{\partial }{\partial φ} r ( φ )}{r ( φ )} ) )} + ( {\sum }_{n = 1}^{N} ( - \frac{{th}_{n} no cos ( - φ + 2 arctan ( \frac{\frac{\partial }{\partial φ} r ( φ )}{r ( φ )} ) )}{{np}_{n} \sqrt{1 - \frac{{no}^{2} {cos ( φ - 2 arc tan ( \frac{\frac{\partial }{\partial φ} r ( φ )}{r ( φ )} ) )}^{2}}{{np}_{n}^{2}}}} ) ) + cot ( φ - 2 arctan ( \frac{\frac{\partial }{\partial φ} r ( φ )}{r ( φ )} ) ) ( {\sum }_{n = 1}^{N} {th}_{n} )$$
Irr(Xt) is a predetermined light intensity at a given cylindrical radial coordinate;
Rad(φ) is an intensity of light emitted by a light source, for which the set of luminaire optics are designed, at elevation angle φ; and
F is a constant.
